(19) United States
(12) Patent Application Publication
(10) Pub. No.: US 2018/0210175 A1
(43) Pub. Date: Jul. 26, 2018

(54) OPTICAL LENS ASSEMBLY

(71) Applicant: GENIUS ELECTRONIC OPTICAL CO., LTD., Taichung City (TW)

(72) Inventors: Jia-Sin Jhang, Taichung City (TW); Baina Chen, Xiamen (CN); Feng Li, Xiamen (CN)

(21) Appl. No.: 15/449,573

(22) Filed: Mar. 3, 2017

(30) Foreign Application Priority Data
Jan. 20, 2017 (CN) 201710051700.7

(51) Int. Cl. G02B 13/00; G02B 9/60

(52) U.S. Cl. CPC G02B 13/0045; G02B 9/60

(57) ABSTRACT

Present embodiments provide for an optical lens assembly. The optical lens assembly includes a first lens element, a second lens element, a third lens element, a fourth lens element, and a fifth lens element positioned in an order from an object side to an image side. Through the arrangement of convex or concave surfaces of the five lens elements, the length of the optical lens assembly may be shortened while providing better optical characteristics and an imaging quality.

### CROSS REFERENCE TO RELATED APPLICATION

This application claims priority to P.R.C. Patent Application No. 201710051700.7, titled “Optical Lens Assembly,” filed Jan. 20, 2017, with the State Intellectual Property Office of the People's Republic of China (SIPO), which is incorporated herein by its entirety.

### TECHNICAL FIELD

The present disclosure relates to an optical lens assembly, and particularly, to an optical lens assembly having five lens elements.

### BACKGROUND

Mobile electronic device technology improves every day and consumers' demands for compact electronic devices haven't decreased. This applies in the context of optical imaging lens characteristics, in that key components for optical imaging lenses incorporated into consumer electronic products should keep pace with technological improvements in order to meet the expectations of consumers. Except for a good imaging quality and a small size of an optical imaging lens, the optical imaging lens further needs a larger field of view.

In this manner, there is a desirable objective for increasing a field of view while maintaining a good imaging quality and a small size.

### SUMMARY

The present disclosure provides for an optical lens assembly. By designing the convex and/or concave surfaces of the five lens elements, the length of the optical lens assembly may be shortened while maintaining good optical characteristics and an imaging quality.

In the present disclosure, parameters used herein may be chosen from but not limited to parameters listed below:

| Parameter | Definition |
|---|---|
| T1 | The central thickness of the first lens element along the optical axis |
| G12 | The air gap between the first lens element and the second lens element along the |
| | optical axis |
| T2 | The central thickness of the second lens element along the optical axis |
| G23 | The air gap between the second lens element and the third lens element along the |
| | optical axis |
| T3 | The central thickness of the third lens element along the optical axis |
| G34 | The air gap between the third lens element and the fourth lens element along the |
| | optical axis |
| T4 | The central thickness of the fourth lens element along the optical axis |
| G45 | The air gap between the fourth lens element and the fifth lens element along the |
| | optical axis |
| T5 | The central thickness of the fifth lens element along the optical axis |
| G5F | The air gap between the fifth lens element and the filtering unit along the optical |
| | axis |
| TF | The central thickness of the filtering unit along the optical axis |
| GFP | The air gap between the filtering unit and an image plane along the optical axis |
| f1 | The focusing length of the first lens element |
| f2 | The focusing length of the second lens element |
| f3 | The focusing length of the third lens element |
| f4 | The focusing length of the fourth lens element |
| f5 | The focusing length of the fifth lens element |
| n1 | The refracting index of the first lens element |
| n2 | The refracting index of the second lens element |
| n3 | The refracting index of the third lens element |
| n4 | The refracting index of the fourth lens element |
| n5 | The refracting index of the fifth lens element |
| v1 | The Abbe number of the first lens element |
| v2 | The Abbe number of the second lens element |
| v3 | The Abbe number of the third lens element |
| v4 | The Abbe number of the fourth lens element |
| v5 | The Abbe number of the fifth lens element |
| HFOV | Half Field of View of the optical lens assembly |
| Fno | F-number of the optical lens assembly |
| EFL | The effective focal length of the optical lens assembly |
| TTL | The distance from the object-side surface of the first lens element to an image |
| | plane along the optical axis |
| ALT | The sum of the central thicknesses from the first lens element to the fifth lens |
| | element |
| AAG | The sum of all air gaps from the first lens element to the fifth lens element along |
| | the optical axis |
| BFL | The back focal length of the optical lens assembly/The distance from the image- |
| | side surface of the fifth lens element to the image plane along the optical axis |
| TL | The distance from the object-side surface of the first lens element to the image- |
| | side surface of the fifth lens element along the optical axis |

In one embodiment, an optical lens assembly may comprise sequentially from an object side to an image side along an optical axis, a first, second, third, fourth, and fifth lens elements. Each of the first, second, third, fourth, and fifth lens elements have varying refracting power in some embodiments. Additionally, each of the first to fifth lens elements may comprise an object-side surface facing toward the object side, an image-side surface facing toward the image side, and a central thickness defined along the optical axis. Moreover, the image-side surface of the first lens element may comprise a concave portion in a vicinity of the optical axis, the object-side surface of the second lens element may comprise a convex portion in a vicinity of the optical axis and a concave portion in a vicinity of a periphery of the second lens element, the image-side surface of the second lens element may comprise a concave portion in a vicinity of the optical axis, the object-side surface of the fourth lens element may comprise a concave portion in a vicinity of the optical axis, the image-side surface of the fifth lens element may comprise a concave portion in a vicinity of the optical axis, and the optical lens assembly may satisfy three inequalities as follows:

V3+V4+V5≥150 Inequality (1);

(T2+T4+G23)/T5≤2.21 Inequality(2); and

TTL/AAG≤4.5 Inequality(3).

Moreover, the above embodiment of the optical lens assembly may comprise no other lenses having refracting power beyond the five lens elements, while it may satisfy any one of inequalities as follows:

(T1+G23)/G12≤7.4 Inequality (4);

(T2+G23)/G12≤4.7 Inequality (5);

(T1+G23)/G34≤2 Inequality (6);

(T1+T2+T3)/T4≤3.1 Inequality (7);

(T1+G23+T3)/T4≤2.84 Inequality (8);

ALT/(G12+G34)≤3.81 Inequality (9);

ALT/(G12+G34)≤3.81 Inequality (9);

ALT/T5≤5.36 Inequality (10);

EFL/T1≤7.81 Inequality (11);

TTL/(T4+T5)≤5.7 Inequality (12).

In another embodiment, an optical lens assembly may comprise sequentially from an object side to an image side along an optical axis, a first, second, third, fourth, and fifth lens elements. Each of the first, second, third, fourth, and fifth lens elements have varying refracting power in some embodiments. Additionally, each of the first to fifth lens elements may comprise an object-side surface facing toward the object side, an image-side surface facing toward the image side, and a central thickness defined along the optical axis. Moreover, the image-side surface of the first lens element may comprise a concave portion in a vicinity of the optical axis, the object-side surface of the second lens element may comprise a convex portion in a vicinity of the optical axis and a concave portion in a vicinity of a periphery of the second lens element, the image-side surface of the third lens element may comprise a convex portion in a vicinity of the optical axis, the object-side surface of the fourth lens element may comprise a concave portion in a vicinity of the optical axis, the image-side surface of the fifth lens element may comprise a concave portion in a vicinity of the optical axis, and the optical lens assembly may satisfy three inequalities as follows:

V3+V4+V5≥150 Inequality (1);

(T2+T4+G23)/T5≤2.21 Inequality(2); and

TTL/AAG≤3.5 Inequality(13).

Moreover, the above embodiment of the optical lens assembly may comprise no other lenses having refracting power beyond the five lens elements, while it may satisfy any one of inequalities as follows:

(T3+G23)/G12≤6.8 Inequality(14);

(T4+G23)/G12≤7.9 Inequality(15);

(T3+G23)/G34≤1.9 Inequality(16);

(T1+T2+T3)/G45≤6.4 Inequality(17);

(T1+G23+T3)/G45≤5.41 Inequality(18);

ALT/(G23+G34)≤3.31 Inequality(19);

ALT/AAG≤2.5 Inequality(20).

### BRIEF DESCRIPTION OF THE DRAWINGS

Exemplary embodiments will be more readily understood from the following detailed description when read in conjunction with the appended drawing, in which:

FIG. 1 depicts a cross-sectional view of one single lens element according to the present disclosure;

FIG. 2 depicts a schematic view of the relation between the surface shape and the optical focus of the lens element;

FIG. 3 depicts a schematic view of a first example of the surface shape and the effective radius of the lens element;

FIG. 4 depicts a schematic view of a second example of the surface shape and the effective radius of the lens element;

FIG. 5 depicts a schematic view of a third example of the surface shape and the effective radius of the lens element;

FIG. 6 depicts a cross-sectional view of a first embodiment of an optical lens assembly having seven lens elements according to the present disclosure;

FIG. 7 depicts a chart of longitudinal spherical aberration and other kinds of optical aberrations of a first embodiment of the optical lens assembly according to the present disclosure;

FIG. 8 depicts a table of optical data for each lens element of the optical lens assembly of a first embodiment of the present disclosure;

FIG. 9 depicts a table of aspherical data of a first embodiment of the optical lens assembly according to the present disclosure;

FIG. 10 depicts a cross-sectional view of a second embodiment of an optical lens assembly having seven lens elements according to the present disclosure;

FIG. 11 depicts a chart of longitudinal spherical aberration and other kinds of optical aberrations of a second embodiment of the optical lens assembly according the present disclosure;

FIG. 12 depicts a table of optical data for each lens element of the optical lens assembly of a second embodiment of the present disclosure;

FIG. 13 depicts a table of aspherical data of a second embodiment of the optical lens assembly according to the present disclosure;

FIG. 14 depicts a cross-sectional view of a third embodiment of an optical lens assembly having seven lens elements according to the present disclosure;

FIG. 15 depicts a chart of longitudinal spherical aberration and other kinds of optical aberrations of a third embodiment of the optical lens assembly according the present disclosure;

FIG. 16 depicts a table of optical data for each lens element of the optical lens assembly of a third embodiment of the present disclosure;

FIG. 17 depicts a table of aspherical data of a third embodiment of the optical lens assembly according to the present disclosure;

FIG. 18 depicts a cross-sectional view of a fourth embodiment of an optical lens assembly having seven lens elements according to the present disclosure;

FIG. 19 depicts a chart of longitudinal spherical aberration and other kinds of optical aberrations of a fourth embodiment of the optical lens assembly according the present disclosure;

FIG. 20 depicts a table of optical data for each lens element of the optical lens assembly of a fourth embodiment of the present disclosure;

FIG. 21 depicts a table of aspherical data of a fourth embodiment of the optical lens assembly according to the present disclosure;

FIG. 22 depicts a cross-sectional view of a fifth embodiment of an optical lens assembly having seven lens elements according to the present disclosure;

FIG. 23 depicts a chart of longitudinal spherical aberration and other kinds of optical aberrations of a fifth embodiment of the optical lens assembly according the present disclosure;

FIG. 24 depicts a table of optical data for each lens element of the optical lens assembly of a fifth embodiment of the present disclosure;

FIG. 25 depicts a table of aspherical data of a fifth embodiment of the optical lens assembly according to the present disclosure;

FIG. 26 depicts a cross-sectional view of a sixth embodiment of an optical lens assembly having seven lens elements according to the present disclosure;

FIG. 27 depicts a chart of longitudinal spherical aberration and other kinds of optical aberrations of a sixth embodiment of the optical lens assembly according to the present disclosure;

FIG. 28 depicts a table of optical data for each lens element of a sixth embodiment of an optical lens assembly according to the present disclosure;

FIG. 29 depicts a table of aspherical data of a sixth embodiment of the optical lens assembly according to the present disclosure;

FIG. 30 depicts a cross-sectional view of a seventh embodiment of an optical lens assembly having seven lens elements according to the present disclosure;

FIG. 31 depicts a chart of longitudinal spherical aberration and other kinds of optical aberrations of a seventh embodiment of the optical lens assembly according to the present disclosure;

FIG. 32 depicts a table of optical data for each lens element of the optical lens assembly of a seventh embodiment of the present disclosure;

FIG. 33 depicts a table of aspherical data of a seventh embodiment of the optical lens assembly according to the present disclosure;

FIG. 34 depicts a cross-sectional view of an eighth embodiment of an optical lens assembly having seven lens elements according to the present disclosure;

FIG. 35 depicts a chart of longitudinal spherical aberration and other kinds of optical aberrations of an eighth embodiment of the optical lens assembly according to the present disclosure;

FIG. 36 depicts a table of optical data for each lens element of the optical lens assembly of an eighth embodiment of the present disclosure;

FIG. 37 depicts a table of aspherical data of an eighth embodiment of the optical lens assembly according to the present disclosure;

FIG. 38 depicts a cross-sectional view of a ninth embodiment of an optical lens assembly having seven lens elements according to the present disclosure;

FIG. 39 depicts a chart of longitudinal spherical aberration and other kinds of optical aberrations of a ninth embodiment of the optical lens assembly according to the present disclosure;

FIG. 40 depicts a table of optical data for each lens element of the optical lens assembly of a ninth embodiment of the present disclosure;

FIG. 41 depicts a table of aspherical data of a ninth embodiment of the optical lens assembly according to the present disclosure;

FIG. 42 depicts a cross-sectional view of a tenth embodiment of an optical lens assembly having seven lens elements according to the present disclosure;

FIG. 43 depicts a chart of longitudinal spherical aberration and other kinds of optical aberrations of a tenth embodiment of the optical lens assembly according to the present disclosure;

FIG. 44 depicts a table of optical data for each lens element of the optical lens assembly of a tenth embodiment of the present disclosure;

FIG. 45 depicts a table of aspherical data of a tenth embodiment of the optical lens assembly according to the present disclosure;

FIG. 46 depicts a cross-sectional view of a eleventh embodiment of an optical lens assembly having seven lens elements according to the present disclosure;

FIG. 47 depicts a chart of longitudinal spherical aberration and other kinds of optical aberrations of a eleventh embodiment of the optical lens assembly according to the present disclosure;

FIG. 48 depicts a table of optical data for each lens element of the optical lens assembly of a eleventh embodiment of the present disclosure;

FIG. 49 depicts a table of aspherical data of a eleventh embodiment of the optical lens assembly according to the present disclosure;

FIG. 50 is a table for values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of the all eleven example embodiments.

### DETAILED DESCRIPTION

For a more complete understanding of the present disclosure and its advantages, reference is now made to the following description taken in conjunction with the accompanying drawings, in which like reference numbers indicate like features. Persons having ordinary skill in the art will understand other varieties for implementing example embodiments, including those described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

In the present disclosure, the description “a lens element having positive refracting power (or negative refracting power)” means that the paraxial refracting power of the lens element in Gaussian optics is positive (or negative). The description “An object-side (or image-side) surface of a lens element” may include a specific region of that surface of the lens element where imaging rays are capable of passing through that region, namely the clear aperture of the surface. The aforementioned imaging rays can be classified into two types, chief ray Lc and marginal ray Lm. Taking a lens element depicted in FIG. 1 as an example, the lens element may be rotationally symmetric, where the optical axis I is the axis of symmetry. The region A of the lens element is defined as “a part in a vicinity of the optical axis”, and the region C of the lens element is defined as “a part in a vicinity of a periphery of the lens element”. Besides, the lens element may also have an extending part E extended radially and outwardly from the region C, namely the part outside of the clear aperture of the lens element. The extending part E may be used for physically assembling the lens element into an optical lens assembly system. Under normal circumstances, the imaging rays would not pass through the extending part E because those imaging rays only pass through the clear aperture. The structures and shapes of the aforementioned extending part E are only examples for technical explanation, the structures and shapes of lens elements should not be limited to these examples. Note that the extending parts of the lens element surfaces depicted in the following embodiments are partially omitted.

The following criteria are provided for determining the shapes and the parts of lens element surfaces set forth in the present disclosure. These criteria mainly determine the boundaries of parts under various circumstances including the part in a vicinity of the optical axis, the part in a vicinity of a periphery of a lens element surface, and other types of lens element surfaces such as those having multiple parts.

FIG. 1 depicts a radial cross-sectional view of a lens element. Before determining boundaries of those aforementioned portions, two referential points should be defined first, the central point and the transition point. The central point of a surface of a lens element is a point of intersection of that surface and the optical axis. The transition point is a point on a surface of a lens element, where the tangent line of that point is perpendicular to the optical axis. Additionally, if multiple transition points appear on one single surface, then these transition points are sequentially named along the radial direction of the surface with numbers starting from the first transition point. For instance, the first transition point (closest one to the optical axis), the second transition point, and the Nth transition point (farthest one to the optical axis within the scope of the clear aperture of the surface). The portion of a surface of the lens element between the central point and the first transition point is defined as the portion in a vicinity of the optical axis. The portion located radially outside of the Nth transition point (but still within the scope of the clear aperture) is defined as the portion in a vicinity of a periphery of the lens element. In some embodiments, there are other portions existing between the portion in a vicinity of the optical axis and the portion in a vicinity of a periphery of the lens element; the numbers of portions depend on the numbers of the transition point(s). In addition, the radius of the clear aperture (or a so-called effective radius) of a surface is defined as the radial distance from the optical axis I to a point of intersection of the marginal ray Lm and the surface of the lens element.

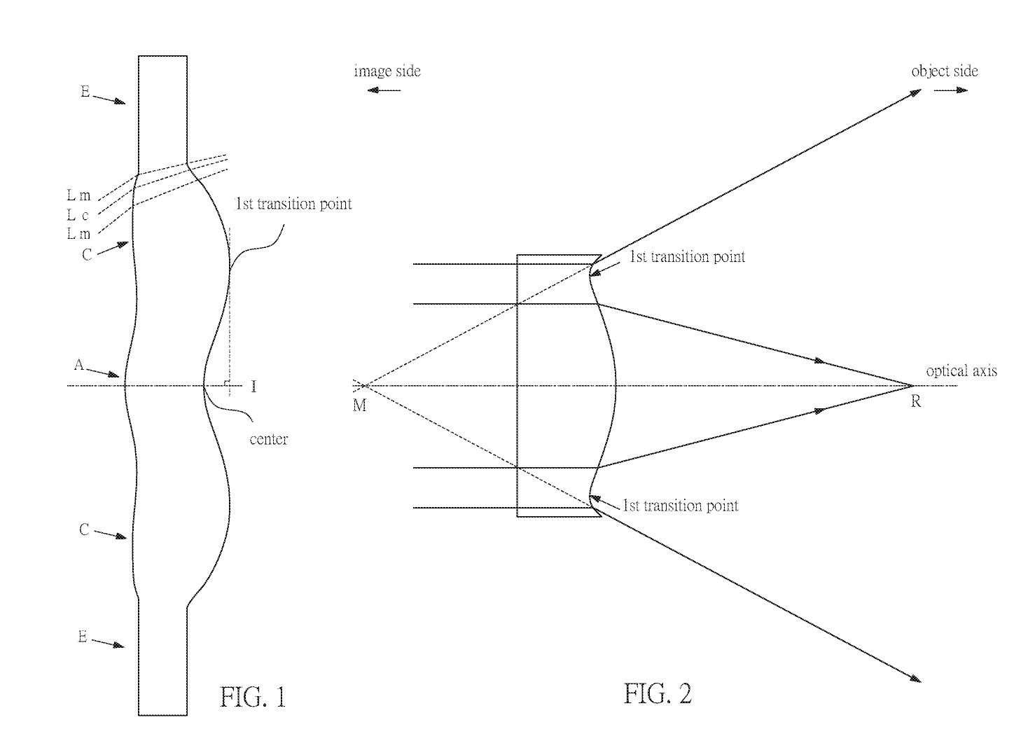

Referring to FIG. 2, determining whether the shape of a portion is convex or concave depends on whether a collimated ray passing through that portion converges or diverges. That is, while applying a collimated ray to a portion to be determined in terms of shape, the collimated ray passing through that portion will be bended and the ray itself or its extension line will eventually meet the optical axis. The shape of that portion can be determined by whether the ray or its extension line meets (intersects) the optical axis (focal point) at the object-side or image-side. For instance, if the ray itself intersects the optical axis at the image side of the lens element after passing through a portion, i.e. the focal point of this ray is at the image side (see point R in FIG. 2), the portion will be determined as having a convex shape. On the contrary, if the ray diverges after passing through a portion, the extension line of the ray intersects the optical axis at the object side of the lens element, i.e. the focal point of the ray is at the object side (see point M in FIG. 2), that portion will be determined as having a concave shape. Therefore, referring to FIG. 2, the portion between the central point and the first transition point may have a convex shape, the portion located radially outside of the first transition point may have a concave shape, and the first transition point is the point where the portion having a convex shape changes to the portion having a concave shape, namely the border of two adjacent portions. Alternatively, there is another method to determine whether a portion in a vicinity of the optical axis may have a convex or concave shape by referring to the sign of an “R” value, which is the (paraxial) radius of curvature of a lens surface. The R value may be used in conventional optical design software such as Zemax and CodeV. The R value usually appears in the lens data sheet in the software. For an object-side surface, positive R means that the object-side surface is convex, and negative R means that the object-side surface is concave. Conversely, for an image-side surface, positive R means that the image-side surface is concave, and negative R means that the image-side surface is convex. The result found by using this method should be consistent as by using the other way mentioned above, which determines surface shapes by referring to whether the focal point of a collimated ray is at the object side or the image side.

For none transition point cases, the portion in a vicinity of the optical axis may be defined as the portion between 0-50% of the effective radius (radius of the clear aperture) of the surface, whereas the portion in a vicinity of a periphery of the lens element may be defined as the portion between 50-100% of effective radius (radius of the clear aperture) of the surface.

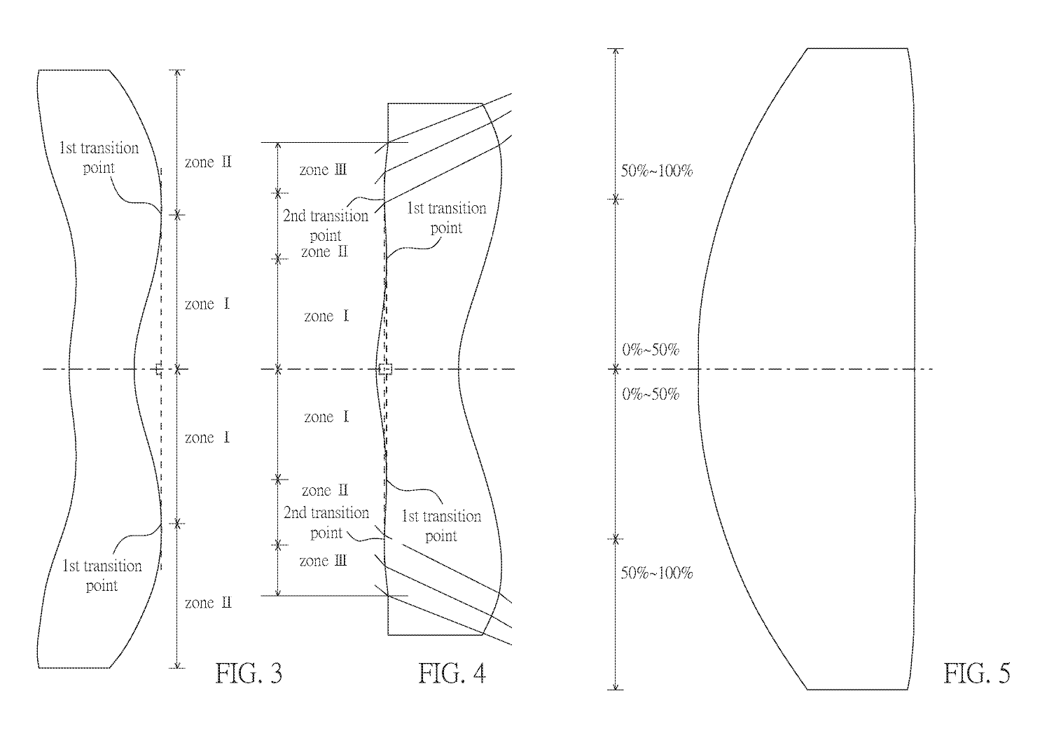

Referring to the first example depicted in FIG. 3, only one transition point, namely a first transition point, appears within the clear aperture of the image-side surface of the lens element. Portion I may be a portion in a vicinity of the optical axis, and portion II may be a portion in a vicinity of a periphery of the lens element. The portion in a vicinity of the optical axis may be determined as having a concave surface due to the R value at the image-side surface of the lens element is positive. The shape of the portion in a vicinity of a periphery of the lens element may be different from that of the radially inner adjacent portion, i.e. the shape of the portion in a vicinity of a periphery of the lens element may be different from the shape of the portion in a vicinity of the optical axis; the portion in a vicinity of a periphery of the lens element may have a convex shape.

Referring to the second example depicted in FIG. 4, a first transition point and a second transition point may exist on the object-side surface (within the clear aperture) of a lens element. In which Here, portion I may be the portion in a vicinity of the optical axis, and portion III may be the portion in a vicinity of a periphery of the lens element. The portion in a vicinity of the optical axis may have a convex shape because the R value at the object-side surface of the lens element may be positive. The portion in a vicinity of a periphery of the lens element (portion III) may have a convex shape. What is more, there may be another portion having a concave shape existing between the first and second transition point (portion II).

Referring to a third example depicted in FIG. 5, no transition point may exist on the object-side surface of the lens element. In this case, the portion between 0-50% of the effective radius (radius of the clear aperture) may be determined as the portion in a vicinity of the optical axis, and the portion between 50-100% of the effective radius may be determined as the portion in a vicinity of a periphery of the lens element. The portion in a vicinity of the optical axis of the object-side surface of the lens element may be determined as having a convex shape due to its positive R value, and the portion in a vicinity of a periphery of the lens element may be determined as having a convex shape as well.

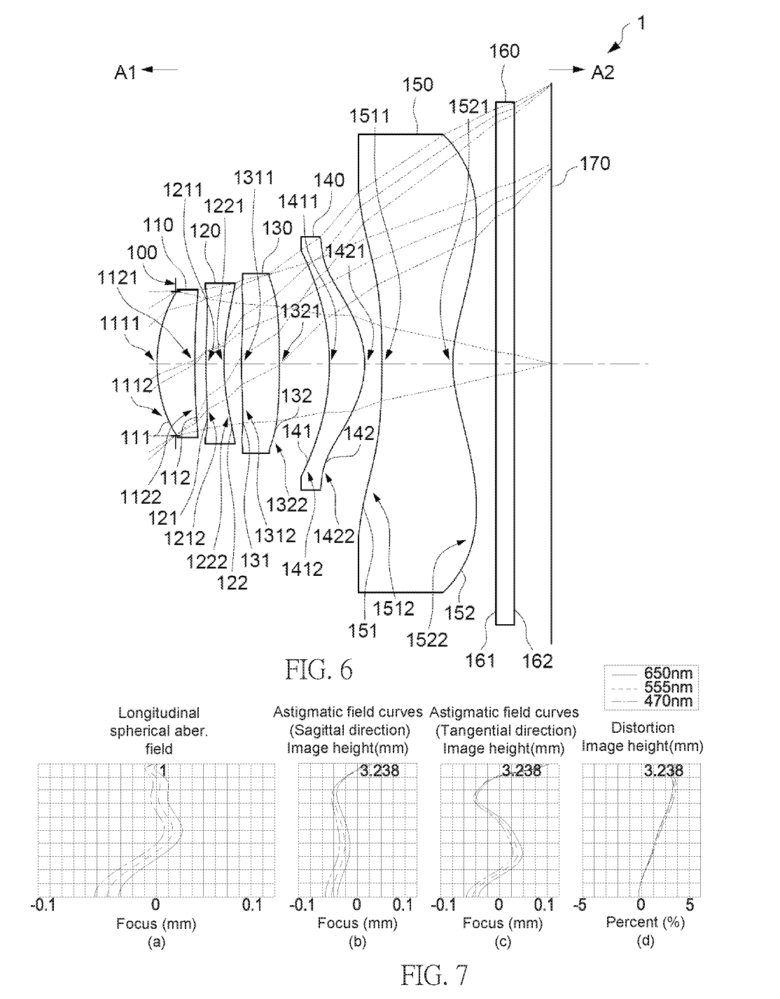

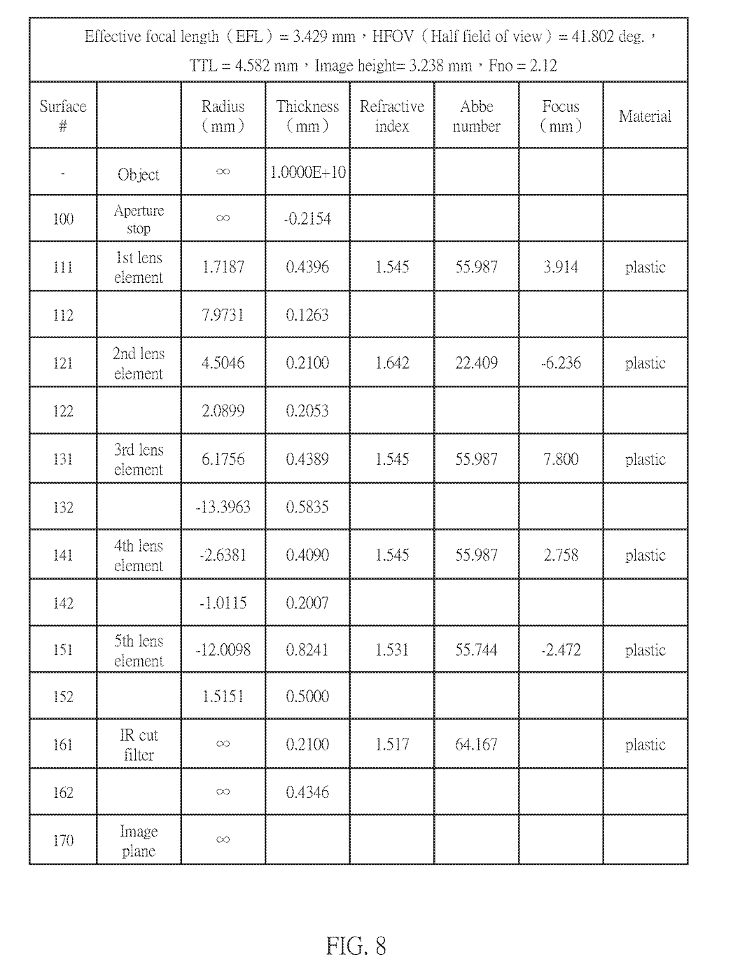

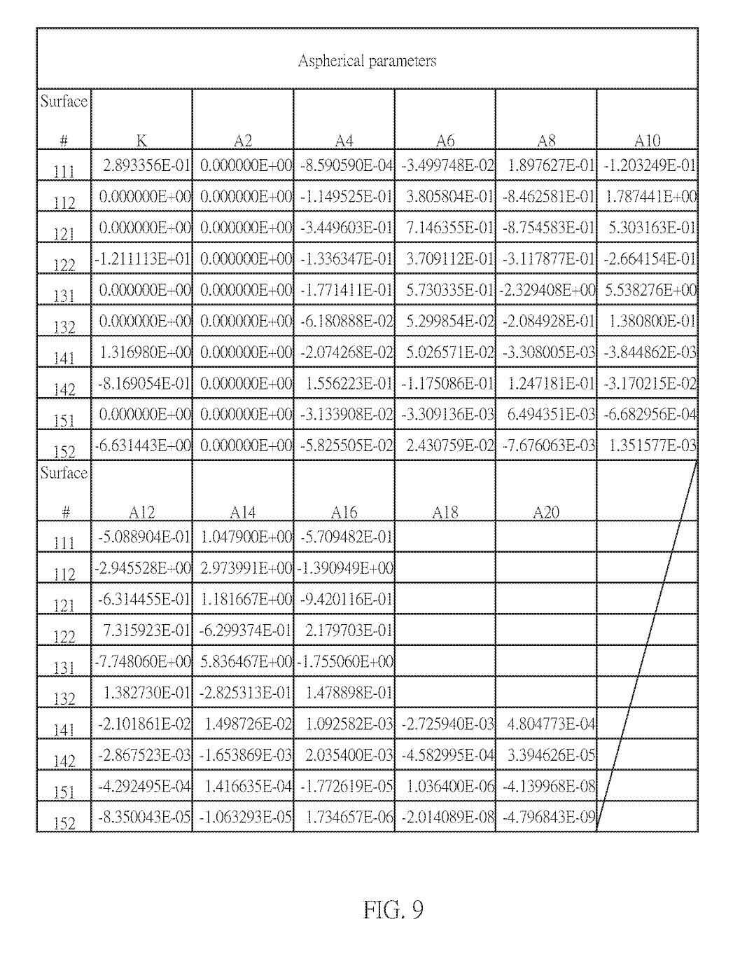

Several exemplary embodiments and associated optical data will now be provided to illustrate non-limiting examples of optical lens assembly systems having good optical characteristics while increasing the field of view. Reference is now made to FIGS. 6-9. FIG. 6 illustrates an example cross-sectional view of an optical lens assembly 1 having six lens elements according to a first example embodiment. FIG. 7 shows example charts of longitudinal spherical aberration and other kinds of optical aberrations of the optical lens assembly 1 according to the first example embodiment. FIG. 8 illustrates an example table of optical data of each lens element of the optical lens assembly 1 according to the first example embodiment. FIG. 9 depicts an example table of aspherical data of the optical lens assembly 1 according to the first example embodiment.

As shown in FIG. 6, the optical lens assembly 1 of the present embodiment may comprise, in order from an object side A1 to an image side A2 along an optical axis, an aperture stop 100, a first lens element 110, a second lens element 120, a third lens element 130, a fourth lens element 140, and a fifth lens element 150. A filtering unit 160 and an image plane 170 of an image sensor (not shown) are positioned at the image side A2 of the optical lens assembly 1. Each of the first, second, third, fourth, and fifth lens elements 110, 120, 130, 140, 150 and the filtering unit 160 may comprise an object-side surface 111/121/131/141/151/161 facing toward the object side A1 and an image-side surface 112/122/132/142/152/162 facing toward the image side A2. The example embodiment of the filtering unit 160 illustrated is an IR cut filter (infrared cut filter) positioned between the fifth lens element 150 and an image plane 170. The filtering unit 160 selectively absorbs light passing optical lens assembly 1 that has a specific wavelength. For example, if IR light is absorbed, IR light which is not seen by human eyes is prohibited from producing an image on the image plane 170.

Exemplary embodiments of each lens element of the optical lens assembly 1 will now be described with reference to the drawings. The lens elements of the optical lens assembly 1 are constructed using plastic material, in some embodiments.

An example embodiment of the first lens element 110 may have positive refracting power. The object-side surface 111 may comprise a convex portion 1111 in a vicinity of an optical axis and a convex portion 1112 in a vicinity of a periphery of the first lens element 110. The image-side surface 112 may comprise a concave portion 1121 in a vicinity of the optical axis and a concave portion 1122 in a vicinity of the periphery of the first lens element 110. The object-side surface 111 and the image-side surface 112 may be aspherical surfaces.

An example embodiment of the second lens element 120 may have negative refracting power. The object-side surface 121 may comprise a convex portion 1211 in a vicinity of the optical axis and a concave portion 1212 in a vicinity of a periphery of the second lens element 120. The image-side surface 122 may comprise a concave portion 1221 in a vicinity of the optical axis and a concave portion 1222 in a vicinity of the periphery of the second lens element 120.

An example embodiment of the third lens element 130 may have positive refracting power. The object-side surface 131 may comprise a convex portion 1311 in a vicinity of the optical axis and a convex portion 1312 in a vicinity of a periphery of the third lens element 130. The image-side surface 132 may comprise a convex portion 1321 in a vicinity of the optical axis and a convex portion 1322 in a vicinity of the periphery of the third lens element 130.

An example embodiment of the fourth lens element 140 may have positive refracting power. The object-side surface 141 may comprise a concave portion 1411 in a vicinity of the optical axis and a concave portion 1412 in a vicinity of a periphery of the fourth lens element 140. The image-side surface 142 may comprise a convex portion 1421 in a vicinity of the optical axis and a convex portion 1422 in a vicinity of the periphery of the fourth lens element 140.

An example embodiment of the fifth lens element 150 may have negative refracting power. The object-side surface 151 may comprise a concave portion 1511 in a vicinity of the optical axis and a concave portion 1512 in a vicinity of a periphery of the fifth lens element 150. The image-side surface 152 may comprise a concave portion 1521 in a vicinity of the optical axis and a convex portion 1522 in a vicinity of the periphery of the fifth lens element 150.

The aspherical surfaces including the object-side surface 111 of the first lens element 110, the image-side surface 112 of the first lens element 110, the object-side surface 121 and the image-side surface 122 of the second lens element 120, the object-side surface 131 and the image-side surface 132 of the third lens element 130, the object-side surface 141 and the image-side surface 142 of the fourth lens element 140, the object-side surface 151 and the image-side surface 152 of the fifth lens element 150 are all defined by the following aspherical formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} {Y}^{i} \qquad formula ( 1 )$$

wherein,

R represents the radius of curvature of the surface of the lens element;

Z represents the depth of the aspherical surface (the perpendicular distance between the point of the aspherical surface at a distance Y from the optical axis and the tangent plane of the vertex on the optical axis of the aspherical surface);

Y represents the perpendicular distance between the point of the aspherical surface and the optical axis;

K represents a conic constant;

aᵢ represents an aspherical coefficient of i^{th} level.

The values of each aspherical parameter are shown in FIG. 9.

FIG. 7(a) shows the longitudinal spherical aberration, wherein the horizontal axis of FIG. 7(a) defines the focus, and the vertical axis of FIG. 7(a) defines the field of view. FIG. 7(b) shows the astigmatism aberration in the sagittal direction, wherein the horizontal axis of FIG. 7(b) defines the focus, and the vertical axis of FIG. 7(b) defines the image height. FIG. 7(c) shows the astigmatism aberration in the tangential direction, wherein the horizontal axis of FIG. 7(c) defines the focus, and the vertical axis of FIG. 7(c) defines the image height. FIG. 7(d) shows the variation of the distortion aberration, wherein the horizontal axis of FIG. 7(d) defines the percentage, and the vertical axis of FIG. 7(d) defines the image height. The three curves with different wavelengths (470 nm, 555 nm, 650 nm) represent that off-axis light with respect to these wavelengths may be focused around an image point. From the vertical deviation of each curve shown in FIG. 7(a), the offset of the off-axis light relative to the image point may be within about ±0.06 mm. Therefore, the first embodiment may improve the longitudinal spherical aberration with respect to different wavelengths. Referring to FIG. 7(b), the focus variation with respect to the three different wavelengths (470 nm, 555 nm, 650 nm) in the whole field may fall within about ±0.06 mm. Referring to FIG. 7(c), the focus variation with respect to the three different wavelengths (470 nm, 555 nm, 650 nm) in the whole field may fall within about ±0.1 mm. Referring to FIG. 7(d), the horizontal axis of FIG. 7(d), the variation of the distortion aberration may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

The distance from the object-side surface 111 of the first lens element 110 to the image plane 170 along the optical axis (TTL) may be about 4.582 mm, EFL may be about 3.429 mm, HFOV may be about 41.802 degrees, the image height may be about 3.28 mm, and Fno may be about 2.118 (the size of aperture decreases while Fno increases). In accordance with these values, the present embodiment may provide an optical lens assembly having a shortened length, and may be capable of accommodating a reduced product profile that also renders a bigger field of view and improved optical performances.

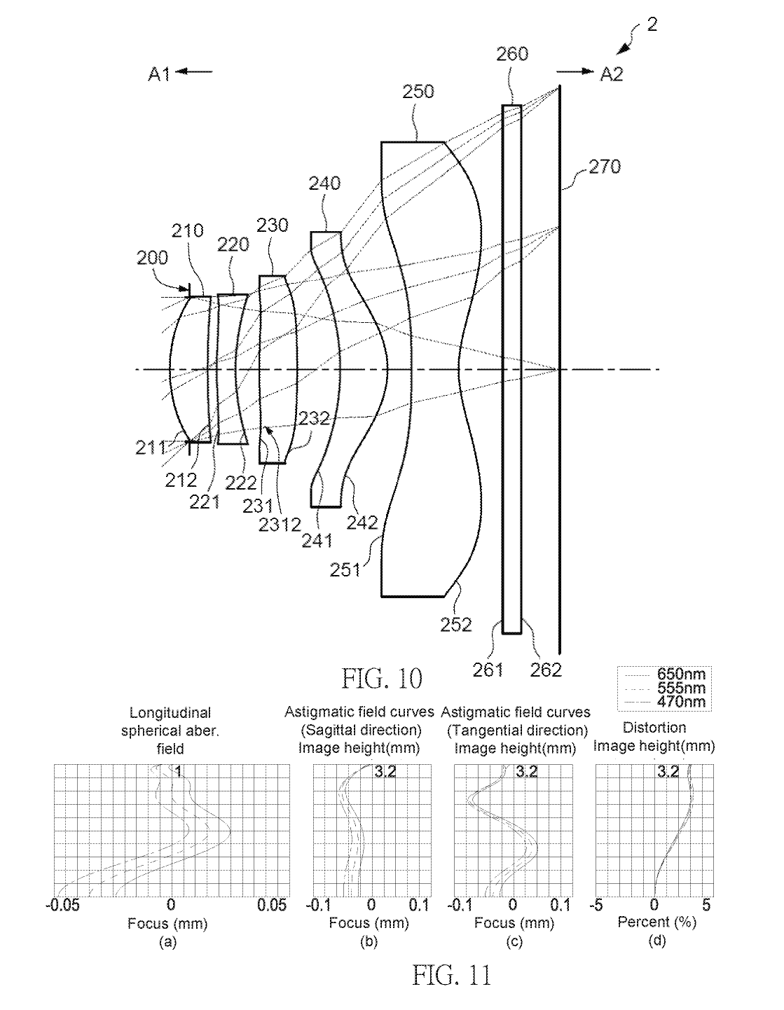

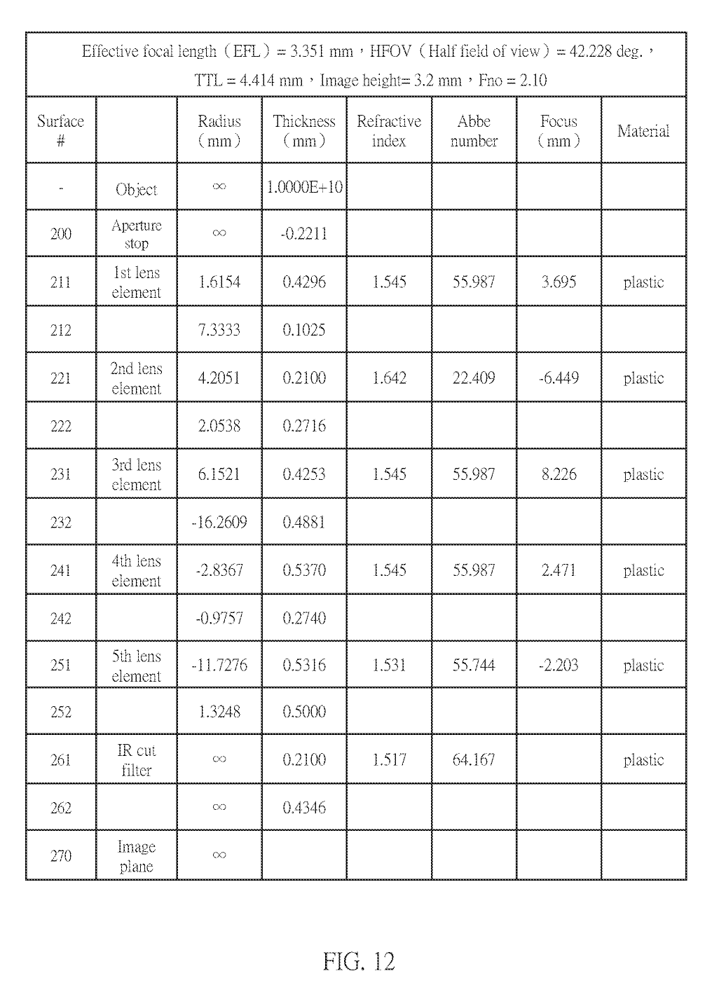

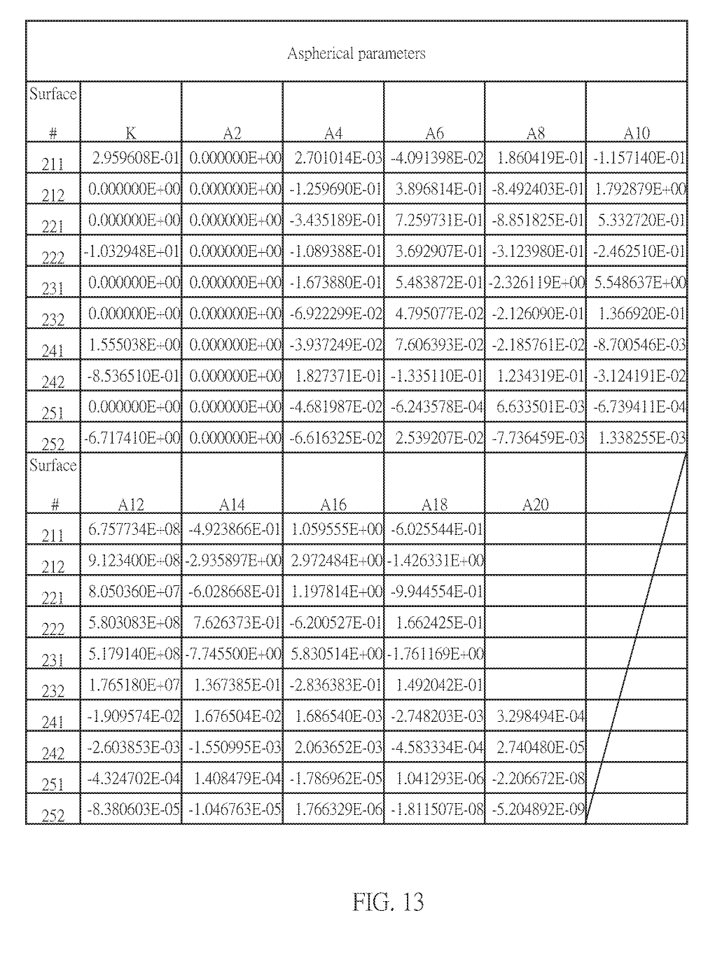

Reference is now made to FIGS. 10-13. FIG. 10 illustrates an example cross-sectional view of an optical lens assembly 2 having seven lens elements according to a second example embodiment. FIG. 11 shows example charts of longitudinal spherical aberration and other kinds of optical aberrations of the optical lens assembly 2 according to the second example embodiment. FIG. 12 shows an example table of optical data of each lens element of the optical lens assembly 2 according to the second example embodiment. FIG. 13 shows an example table of aspherical data of the optical lens assembly 2 according to the second example embodiment. The reference numbers labeled in the present embodiment are similar to those in the first embodiment for the similar elements, but here the reference numbers are initialed with 2, for example, reference number 231 for labeling the object-side surface of the third lens element 230, reference number 232 for labeling the image-side surface of the third lens element 230, etc.

As shown in FIG. 10, the optical lens assembly 2 of the present embodiment, in an order from an object side A1 to an image side A2 along an optical axis, may comprise an aperture stop 200, a first lens element 210, a second lens element 220, a third lens element 230, a fourth lens element 240, and a fifth lens element 250.

The arrangement of the convex or concave surface structures, including the object-side surfaces 211, 221, 241, 251 and the image-side surfaces 212, 222, 232, 242 are generally similar to the optical lens assembly 1, but the differences between the optical lens assembly 1 and the optical lens assembly 2 may include the convex or concave surface structures of the object-side surface 231. Additional differences may include a radius of curvature, a thickness, an aspherical data, and an effective focal length of each lens element. More specifically, the object-side surface 231 of the third lens element 230 may comprise a concave portion 2312 in a vicinity of a periphery of the third lens element 230.

Here, for clearly showing the drawings of the present embodiment, only the surface shapes which are different from that in the first embodiment are labeled. Please refer to FIG. 12 for the optical characteristics of each lens element in the optical lens assembly 2 of the present embodiment.

From the vertical deviation of each curve shown in FIG. 11(a), the offset of the off-axis light relative to the image point may be within about ±0.05 mm. Referring to FIG. 11(b), the focus variation with respect to the three different wavelengths (470 nm, 555 nm, 650 nm) in the whole field may fall within about ±0.06 mm. Referring to FIG. 11(c), the focus variation with respect to the three different wavelengths (470 nm, 555 nm, 650 nm) in the whole field may fall within about ±0.06 mm. Referring to FIG. 11(d), the variation of the distortion aberration of the optical lens assembly 2 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, and the vertical deviation of the curve may be smaller when compared with the first embodiment.

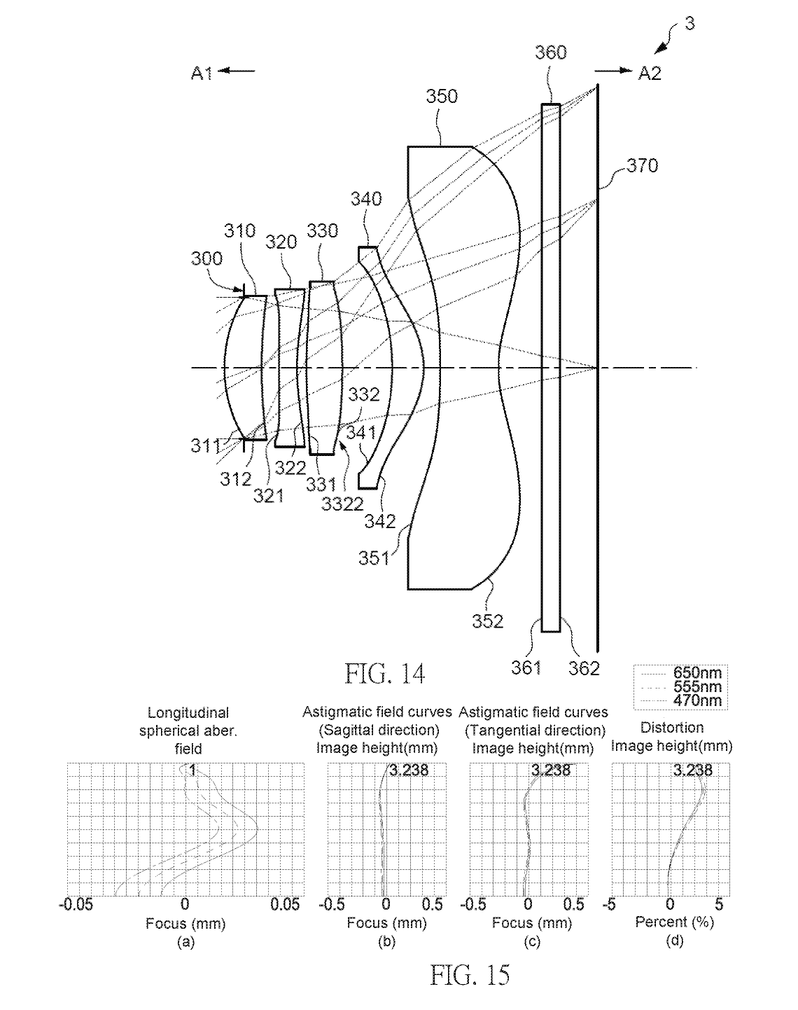

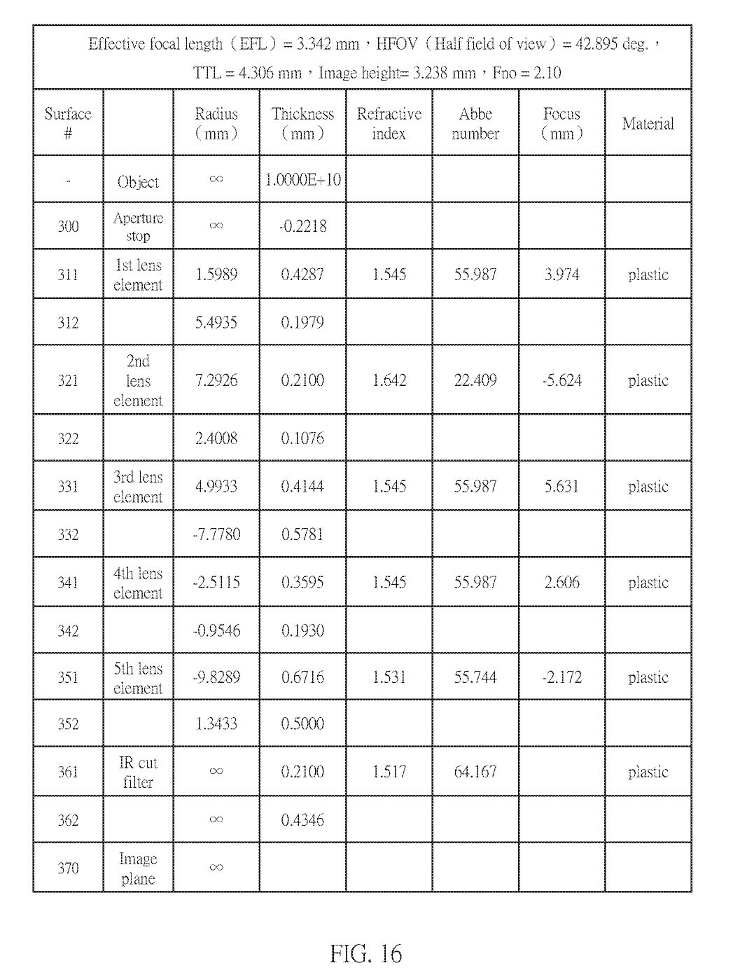

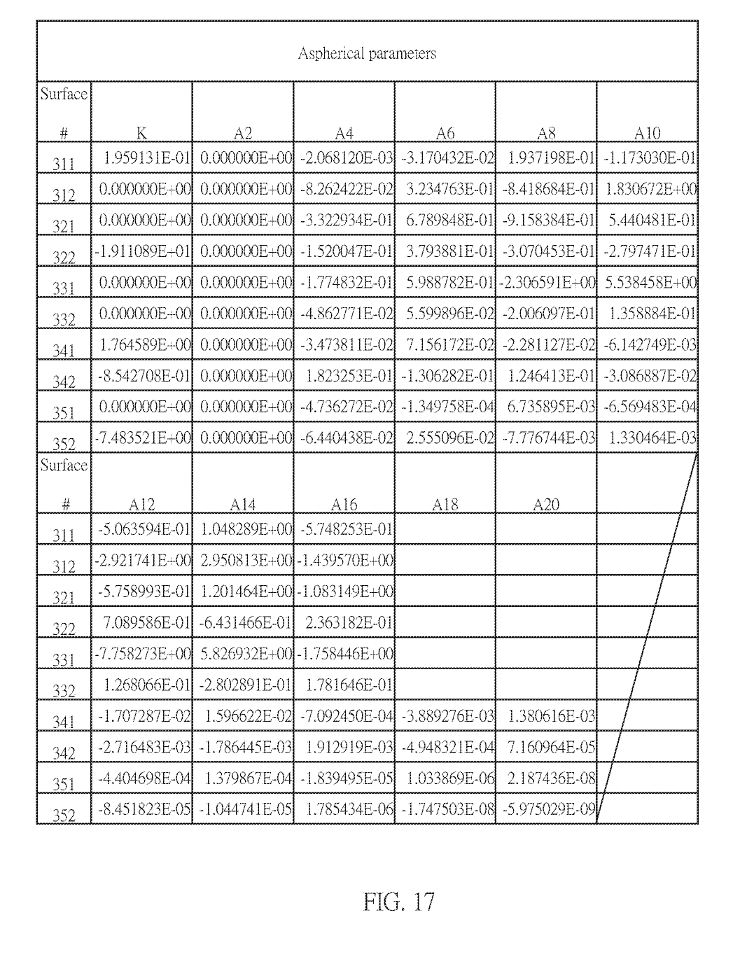

Reference is now made to FIGS. 14-17. FIG. 14 illustrates an example cross-sectional view of an optical lens assembly 3 having seven lens elements according to a third example embodiment. FIG. 15 shows example charts of longitudinal spherical aberration and other kinds of optical aberrations of the optical lens assembly 3 according to the third example embodiment. FIG. 16 shows an example table of optical data of each lens element of the optical lens assembly 3 according to the third example embodiment. FIG. 17 shows an example table of aspherical data of the optical lens assembly 3 according to the third example embodiment. The reference numbers labeled in the present embodiment are similar to those in the first embodiment for the similar elements, but here the reference numbers are initialed with 3, for example, reference number 331 for labeling the object-side surface of the third lens element 330, reference number 332 for labeling the image-side surface of the third lens element 330, etc.

As shown in FIG. 14, the optical lens assembly 3 of the present embodiment, in an order from an object side A1 to an image side A2 along an optical axis, may comprise an aperture stop 300, a first lens element 310, a second lens element 320, a third lens element 330, a fourth lens element 340, and a fifth lens element 350.

The arrangement of the convex or concave surface structures, including the object-side surfaces 311, 321, 331, 341, 351 and the image-side surfaces 312, 322, 342, 352 are generally similar to the optical lens assembly 1, but the differences between the optical lens assembly 1 and the optical lens assembly 3 may include the convex or concave surface structures of the image-side surface 332. Additional differences may include a radius of curvature, a thickness, aspherical data, and an effective focal length of each lens element. More specifically, the image-side surface 332 of the third lens element 330 may comprise a concave portion 3322 in a vicinity of a periphery of the third lens element 330.

Here, for clearly showing the drawings of the present embodiment, only the surface shapes which are different from that in the first embodiment are labeled. Please refer to FIG. 16 for the optical characteristics of each lens element in the optical lens assembly 3 of the present embodiment.

From the vertical deviation of each curve shown in FIG. 15(a), the offset of the off-axis light relative to the image point may be within about ±0.04 mm. Referring to FIG. 15(b), the focus variation with respect to the three different wavelengths (470 nm, 555 nm, 650 nm) in the whole field may fall within about ±0.01 mm. Referring to FIG. 15(c), the focus variation with respect to the three different wavelengths (470 nm, 555 nm, 650 nm) in the whole field may fall within about ±0.5 mm. Referring to FIG. 15(d), the variation of the distortion aberration of the optical lens assembly 3 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, and the vertical deviation of the curve may be smaller when compared with the first embodiment.

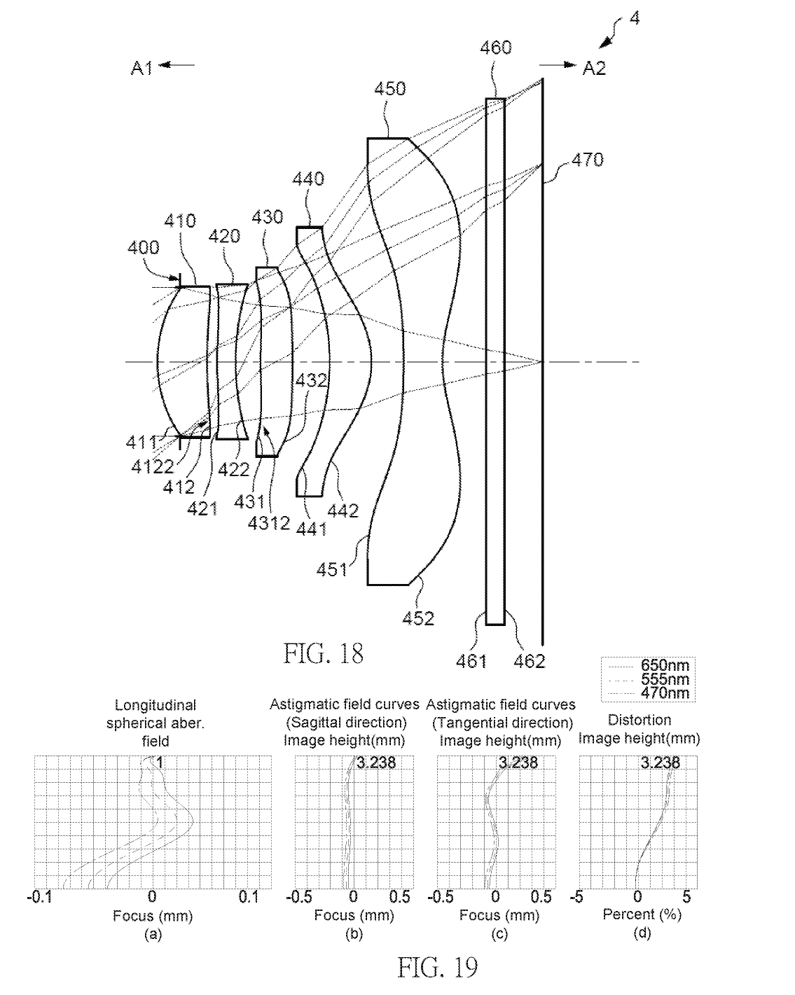

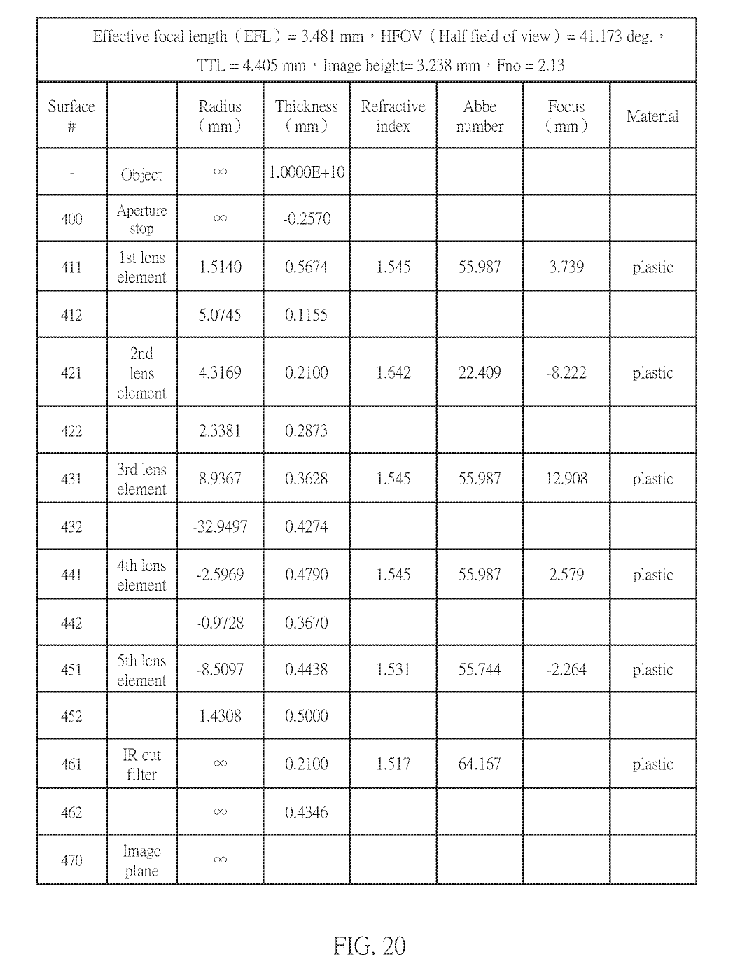

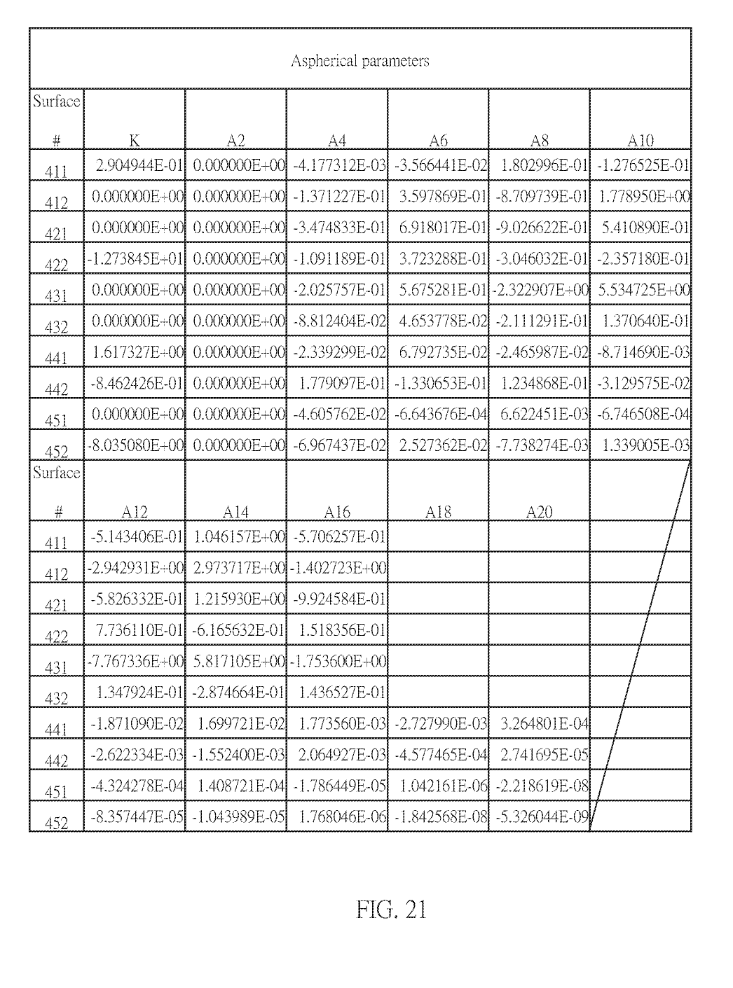

Reference is now made to FIGS. 18-21. FIG. 18 illustrates an example cross-sectional view of an optical lens assembly 4 having seven lens elements according to a fourth example embodiment. FIG. 19 shows example charts of longitudinal spherical aberration and other kinds of optical aberrations of the optical lens assembly 4 according to the fourth embodiment. FIG. 20 shows an example table of optical data of each lens element of the optical lens assembly 4 according to the fourth example embodiment. FIG. 21 shows an example table of aspherical data of the optical lens assembly 4 according to the fourth example embodiment. The reference numbers labeled in the present embodiment are similar to those in the first embodiment for the similar elements, but here the reference numbers are initialed with 4, for example, reference number 431 for labeling the object-side surface of the third lens element 430, reference number 432 for labeling the image-side surface of the third lens element 430, etc.

As shown in FIG. 18, the optical lens assembly 4 of the present embodiment, in an order from an object side A1 to an image side A2 along an optical axis, may comprise an aperture stop 400, a first lens element 410, a second lens element 420, a third lens element 430, a fourth lens element 440, and a fifth lens element 450.

The arrangement of the convex or concave surface structures, including the object-side surfaces 411, 421, 441, 451 and the image-side surfaces 422, 432, 442, 452 are generally similar to the optical lens assembly 1, but the differences between the optical lens assembly 1 and the optical lens assembly 4 may include the convex or concave surface structure of the object-side surface 431. Additional differences may include a radius of curvature, a thickness, aspherical data, and an effective focal length of each lens element. More specifically, the image-side surface 412 of the first lens element 410 may comprise a convex portion 4122 in a vicinity of a periphery of the first lens element 410, the object-side surface 431 of the third lens element 430 may comprise a concave portion 4312 in a vicinity of a periphery of the third lens element 430.

Here, for clearly showing the drawings of the present embodiment, only the surface shapes which are different from that in the first embodiment are labeled. Please refer to FIG. 20 for the optical characteristics of each lens elements in the optical lens assembly 4 of the present embodiment.

From the vertical deviation of each curve shown in FIG. 19(a), the offset of the off-axis light relative to the image point may be within about ±0.08 mm. Referring to FIG. 19(b), the focus variation with respect to the three different wavelengths (470 nm, 555 nm, 650 nm) in the whole field may fall within about ±0.1 mm. Referring to FIG. 19(c), the focus variation with respect to the three different wavelengths (470 nm, 555 nm, 650 nm) in the whole field may fall within about ±0.3 mm. Referring to FIG. 19(d), the variation of the distortion aberration of the optical lens assembly 4 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller when compared with the first embodiment.

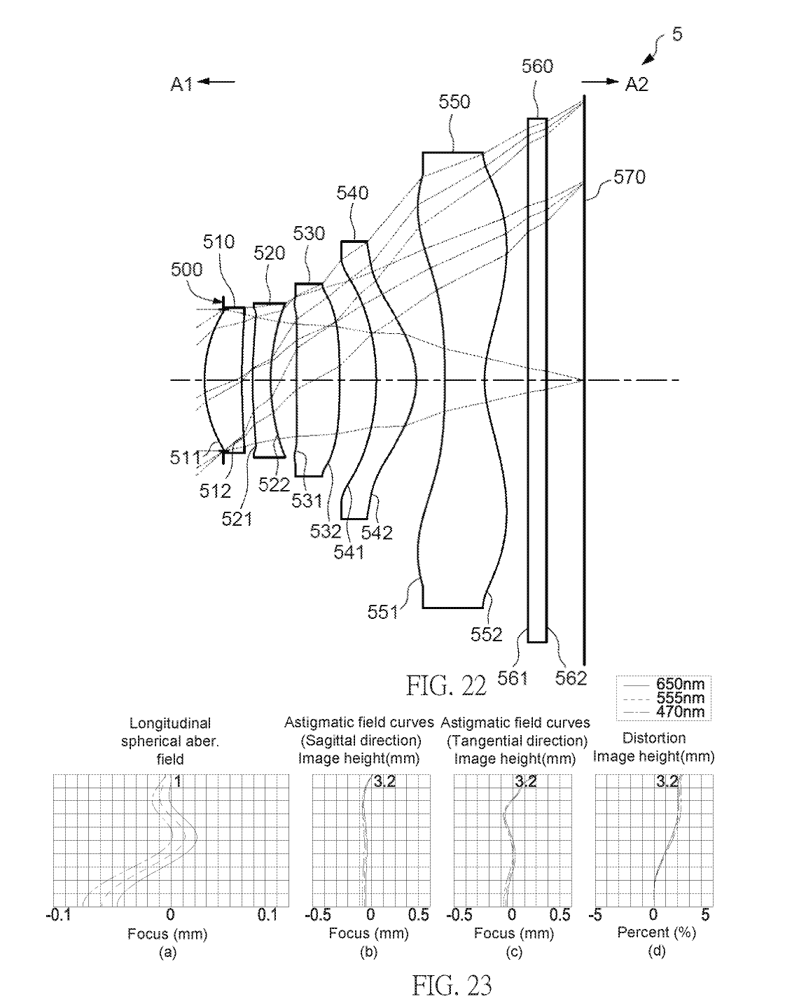

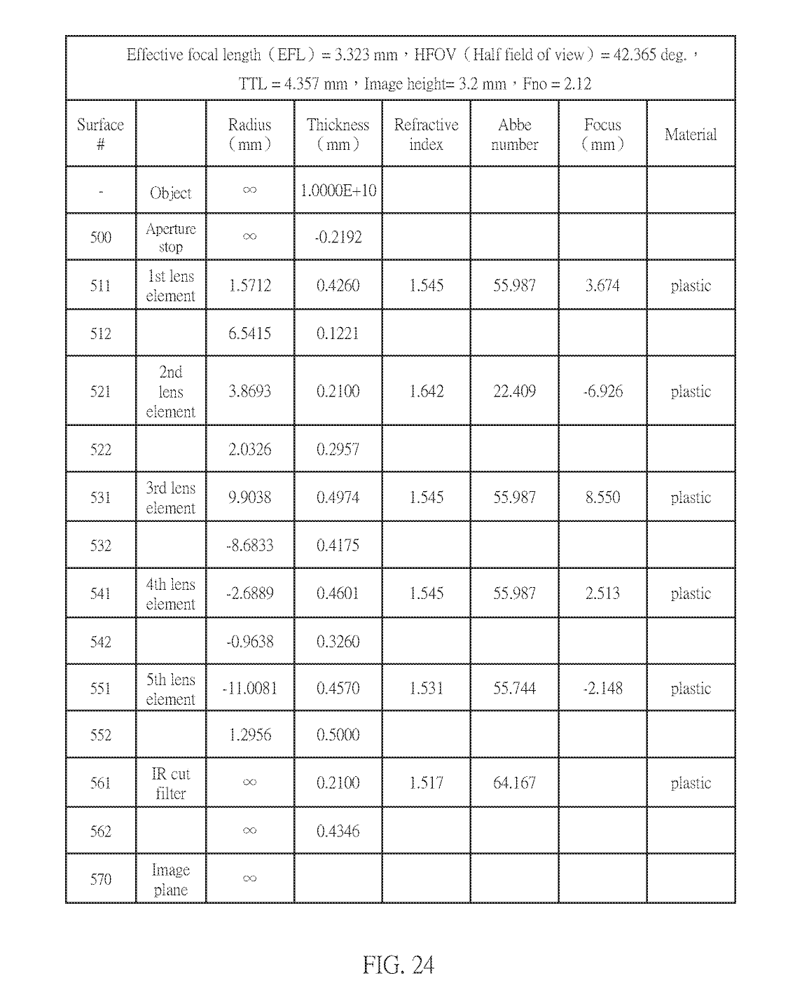

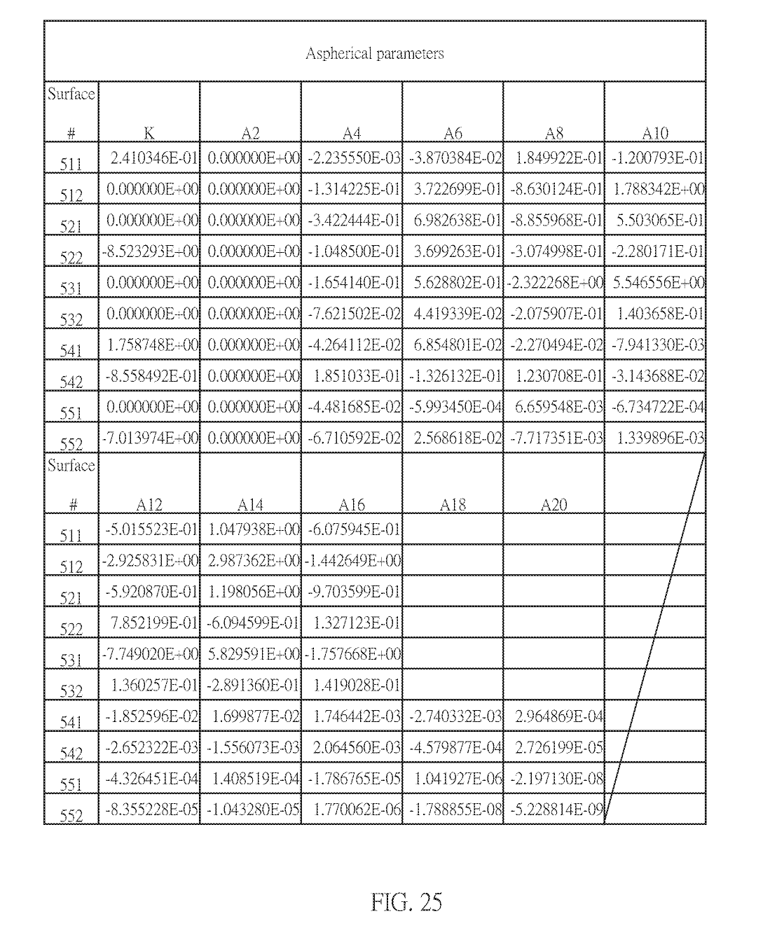

Reference is now made to FIGS. 22-25. FIG. 22 illustrates an example cross-sectional view of an optical lens assembly 5 having seven lens elements according to a fifth example embodiment. FIG. 23 shows example charts of longitudinal spherical aberration and other kinds of optical aberrations of the optical lens assembly 5 according to the fifth embodiment. FIG. 24 shows an example table of optical data of each lens element of the optical lens assembly 5 according to the fifth example embodiment. FIG. 25 shows an example table of aspherical data of the optical lens assembly 5 according to the fifth example embodiment. The reference numbers labeled in the present embodiment are similar to those in the first embodiment for the similar elements, but here the reference numbers are initialed with 5, for example, reference number 531 for labeling the object-side surface of the third lens element 530, reference number 532 for labeling the image-side surface of the third lens element 530, etc.

As shown in FIG. 22, the optical lens assembly 5 of the present embodiment, in an order from an object side A1 to an image side A2 along an optical axis, may comprise an aperture stop 500, a first lens element 510, a second lens element 520, a third lens element 530, a fourth lens element 540, and a fifth lens element 550.

The arrangement of the convex or concave surface structures, including the object-side surfaces 511, 521, 531, 541, 551 and the image-side surfaces 512, 522, 532, 542, 552 are generally similar to the optical lens assembly 1. Additional differences may include a radius of curvature, a thickness, aspherical data, and an effective focal length of each lens element.

Here, for clearly showing the drawings of the present embodiment, only the surface shapes which are different from that in the first embodiment are labeled. FIG. 24 depicts the optical characteristics of each lens elements in the optical lens assembly 5 of the present embodiment.

From the vertical deviation of each curve shown in FIG. 23(a), the offset of the off-axis light relative to the image point may be within about ±0.08 mm. Referring to FIG. 23(b), the focus variation with respect to the three different wavelengths (470 nm, 555 nm, 650 nm) in the whole field may fall within about ±0.1 mm. Referring to FIG. 23(c), the focus variation with respect to the three different wavelengths (470 nm, 555 nm, 650 nm) in the whole field may fall within about ±0.25 mm. Referring to FIG. 23(d), the variation of the distortion aberration of the optical lens assembly 5 may be within about ±3%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the half of field of view may be bigger, and the variation of the distortion aberration may be smaller when compared with the first embodiment.

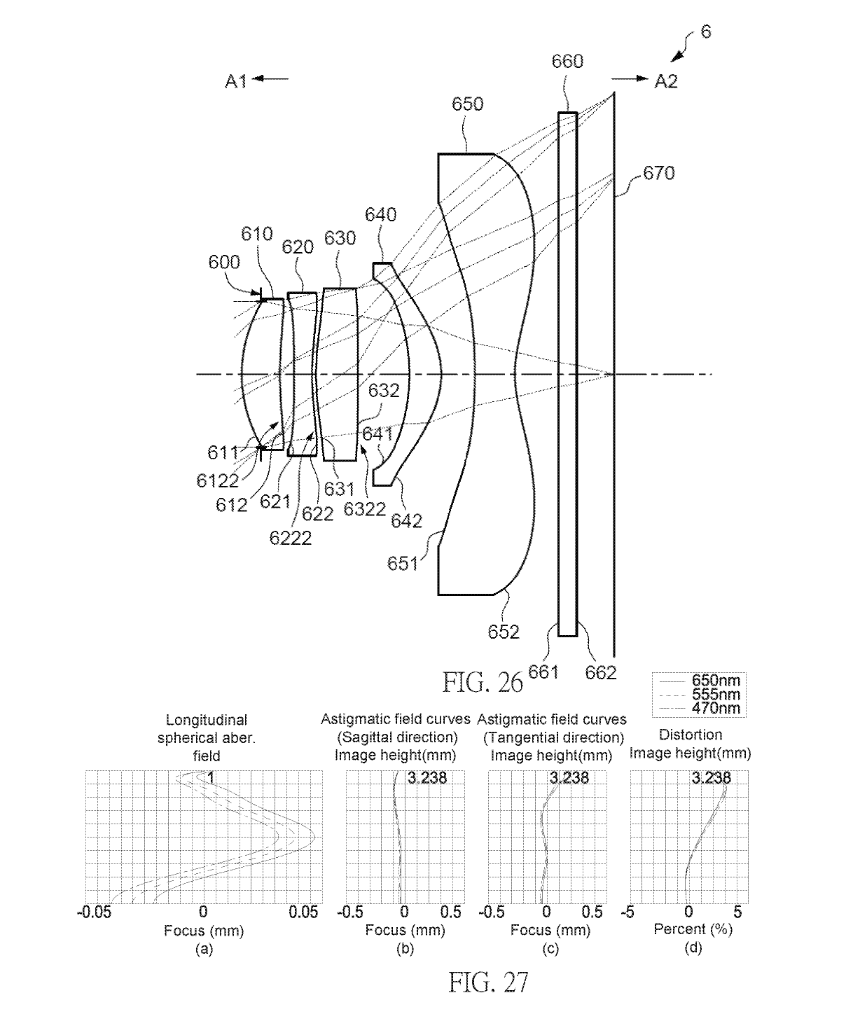

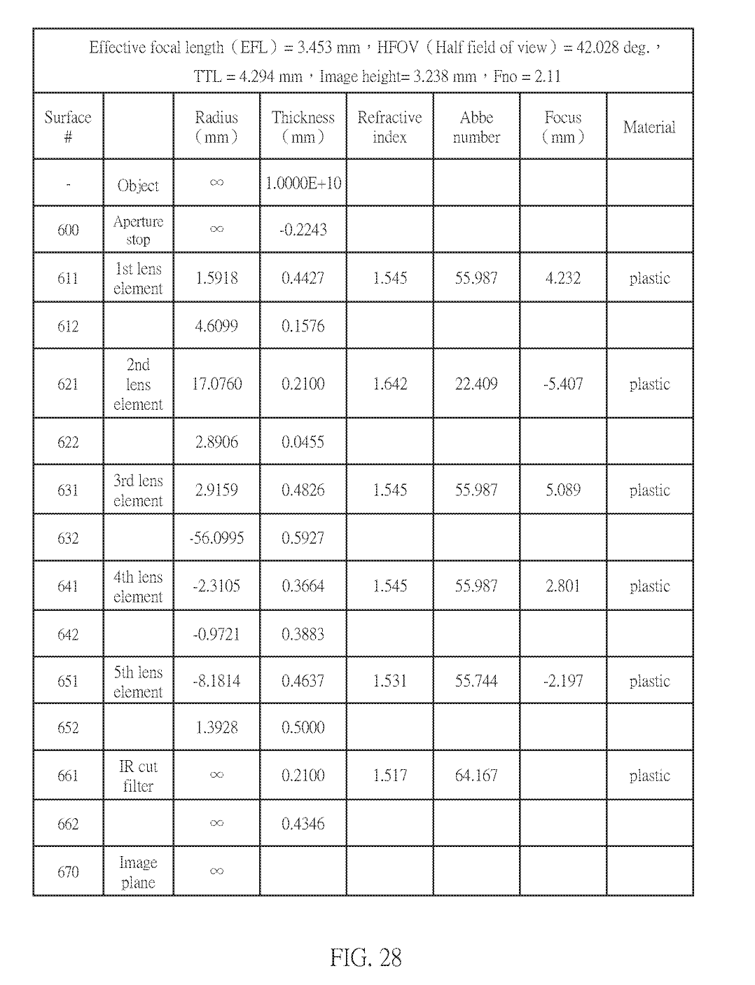

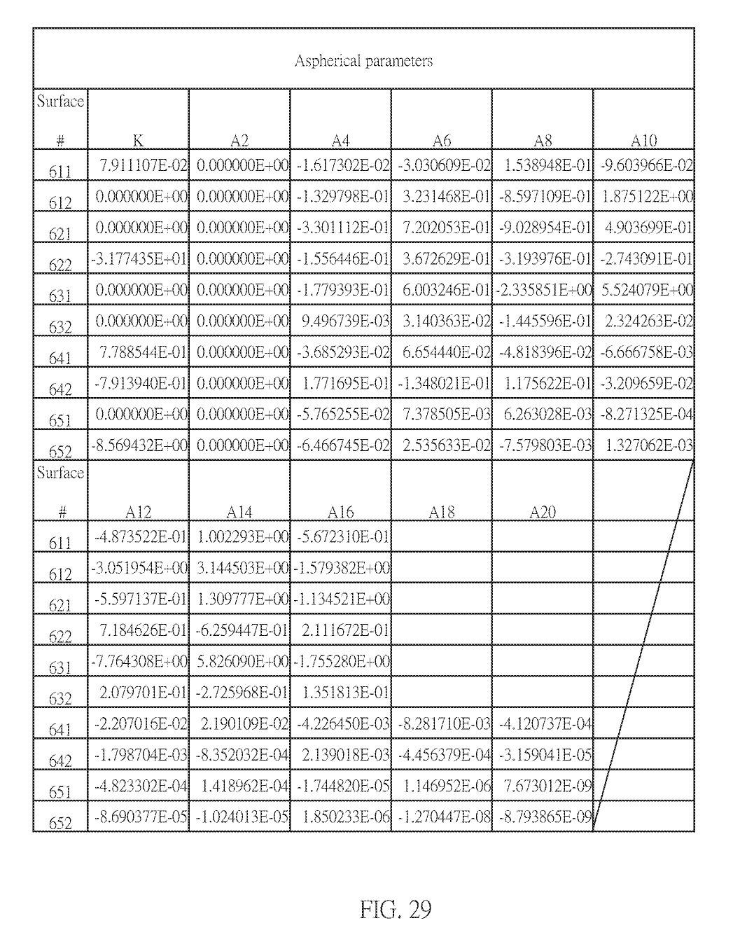

Reference is now made to FIGS. 26-29. FIG. 26 illustrates an example cross-sectional view of an optical lens assembly 6 having seven lens elements according to a sixth example embodiment. FIG. 27 shows example charts of longitudinal spherical aberration and other kinds of optical aberrations of the optical lens assembly 6 according to the sixth embodiment. FIG. 28 shows an example table of optical data of each lens element of the optical lens assembly 6 according to the sixth example embodiment. FIG. 29 shows an example table of aspherical data of the optical lens assembly 6 according to the sixth example embodiment. The reference numbers labeled in the present embodiment are similar to those in the first embodiment for the similar elements, but here the reference numbers are initialed with 6, for example, reference number 631 for labeling the object-side surface of the third lens element 630, reference number 632 for labeling the image-side surface of the third lens element 630, etc.

As shown in FIG. 26, the optical lens assembly 6 of the present embodiment, in an order from an object side A1 to an image side A2 along an optical axis, may comprise an aperture stop 600, a first lens element 610, a second lens element 620, a third lens element 630, a fourth lens element 640, and a fifth lens element 650.

The arrangement of the convex or concave surface structures, including the object-side surfaces 611, 621, 631, 641, 651 and the image-side surfaces 642, 652 are generally similar to the optical lens assembly 1, but the differences between the optical lens assembly 1 and the optical lens assembly 6 may include the convex or concave surface structures of the image-side surfaces 612, 622, 632. Additional differences may include a radius of curvature, a thickness, aspherical data, and an effective focal length of each lens element. More specifically, the image-side surface 612 of the first lens element 610 may comprise a convex portion 6122 in a vicinity of a periphery of the first lens element 610, the image-side surface 622 of the second lens element 620 may comprise a convex portion 6222 in a vicinity of a periphery of the second lens element 620, the image-side surface 632 of the third lens element 630 may comprise a concave portion 6322 in a vicinity of a periphery of the third lens element 630.

Here, for clearly showing the drawings of the present embodiment, only the surface shapes which are different from that in the first embodiment are labeled. Please refer to FIG. 28 for the optical characteristics of each lens elements in the optical lens assembly 6 of the present embodiment.

From the vertical deviation of each curve shown in FIG. 27(a), the offset of the off-axis light relative to the image point may be within about ±0.05 mm. Referring to FIG. 27(b), the focus variation with respect to the three different wavelengths (470 nm, 555 nm, 650 nm) in the whole field may fall within about ±0.1 mm. Referring to FIG. 23(c), the focus variation with respect to the three different wavelengths (470 nm, 555 nm, 650 nm) in the whole field may fall within about ±0.3 mm. Referring to FIG. 27(d), the variation of the distortion aberration of the optical lens assembly 6 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, and the vertical deviation of the curve may be smaller when compared with the first embodiment.

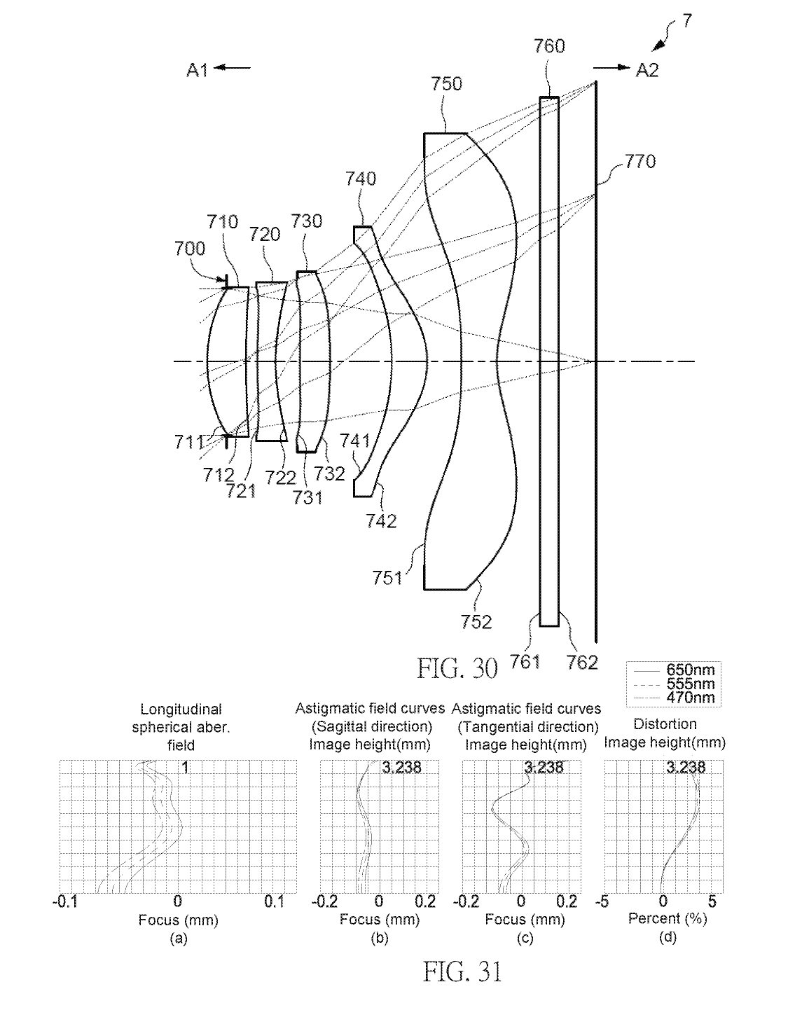

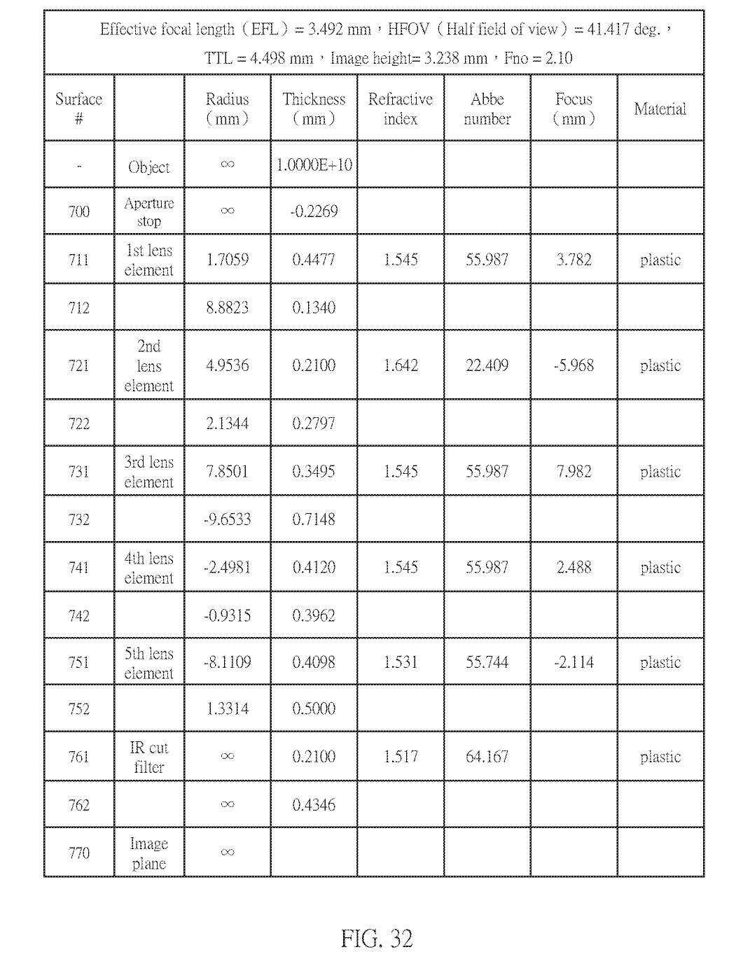

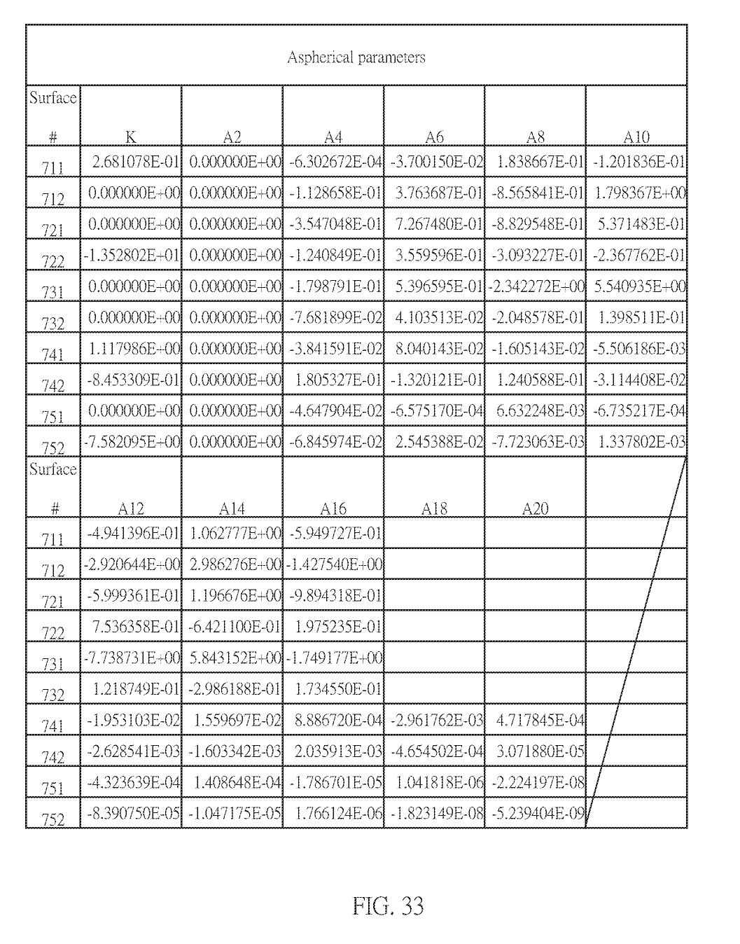

Reference is now made to FIGS. 30-33. FIG. 30 illustrates an example cross-sectional view of an optical lens assembly 7 having seven lens elements according to a seventh example embodiment. FIG. 31 shows example charts of longitudinal spherical aberration and other kinds of optical aberrations of the optical lens assembly 7 according to the seventh embodiment. FIG. 32 shows an example table of optical data of each lens element of the optical lens assembly 7 according to the seventh example embodiment. FIG. 33 shows an example table of aspherical data of the optical lens assembly 7 according to the seventh example embodiment. The reference numbers labeled in the present embodiment are similar to those in the first embodiment for the similar elements, but here the reference numbers are initialed with 7, for example, reference number 731 for labeling the object-side surface of the third lens element 730, reference number 732 for labeling the image-side surface of the third lens element 730, etc.

As shown in FIG. 30, the optical lens assembly 7 of the present embodiment, in an order from an object side A1 to an image side A2 along an optical axis, may comprise an aperture stop 700, a first lens element 710, a second lens element 720, a third lens element 730, fourth lens element 740, and a fifth lens element 750.

The arrangement of the convex or concave surface structures, including the object-side surfaces 711, 721, 731, 741, 751 and the image-side surfaces 712, 722, 732, 742, 752 are generally similar to the optical lens assembly 1. Additional differences may include a radius of curvature, a thickness, aspherical data, and an effective focal length of each lens element.

Here, for clearly showing the drawings of the present embodiment, only the surface shapes which are different from that in the first embodiment are labeled. Please refer to FIG. 32 for the optical characteristics of each lens elements in the optical lens assembly 7 of the present embodiment.

From the vertical deviation of each curve shown in FIG. 31(a), the offset of the off-axis light relative to the image point may be within about ±0.07 mm. Referring to FIG. 31(b), the focus variation with respect to the three different wavelengths (470 nm, 555 nm, 650 nm) in the whole field may fall within about ±0.08 mm. Referring to FIG. 31(c), the focus variation with respect to the three different wavelengths (470 nm, 555 nm, 650 nm) in the whole field may fall within about ±0.16 mm. Referring to FIG. 31(d), the variation of the distortion aberration of the optical lens assembly 7 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller and the size of the aperture stop may be larger when compared with the first embodiment.

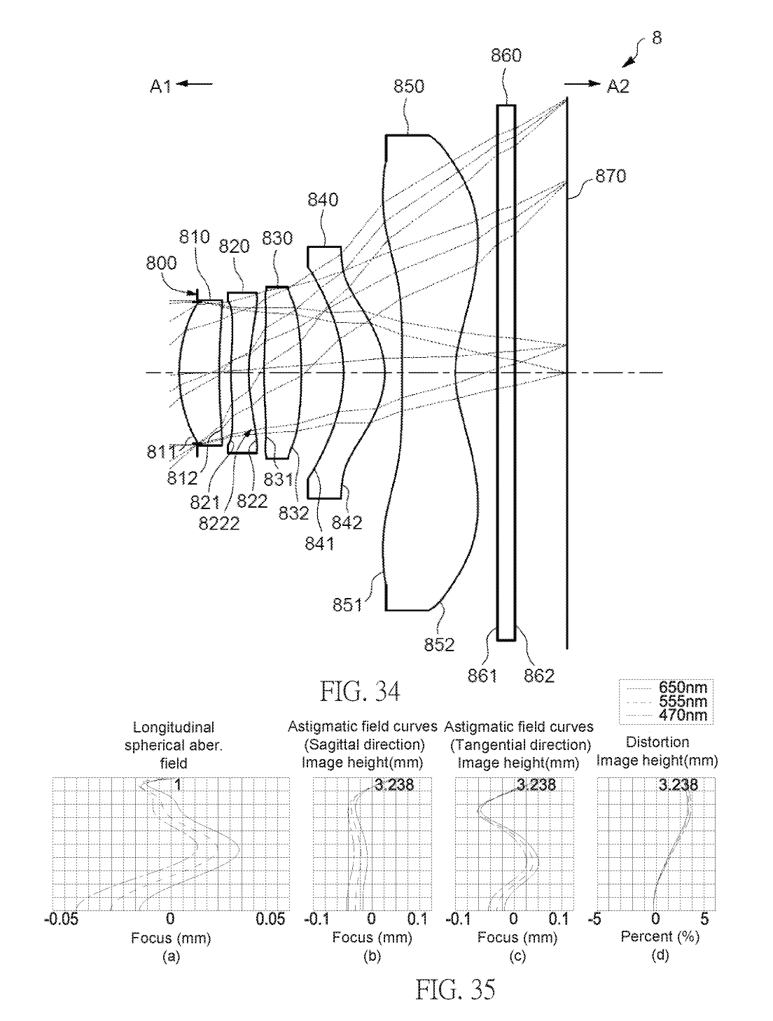

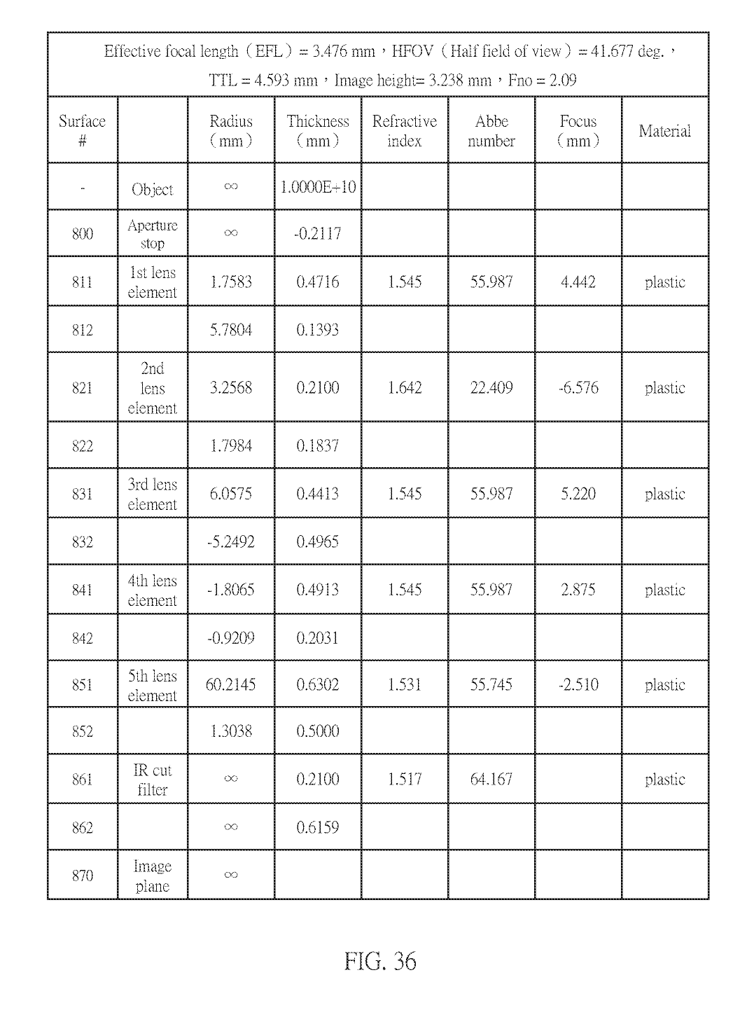

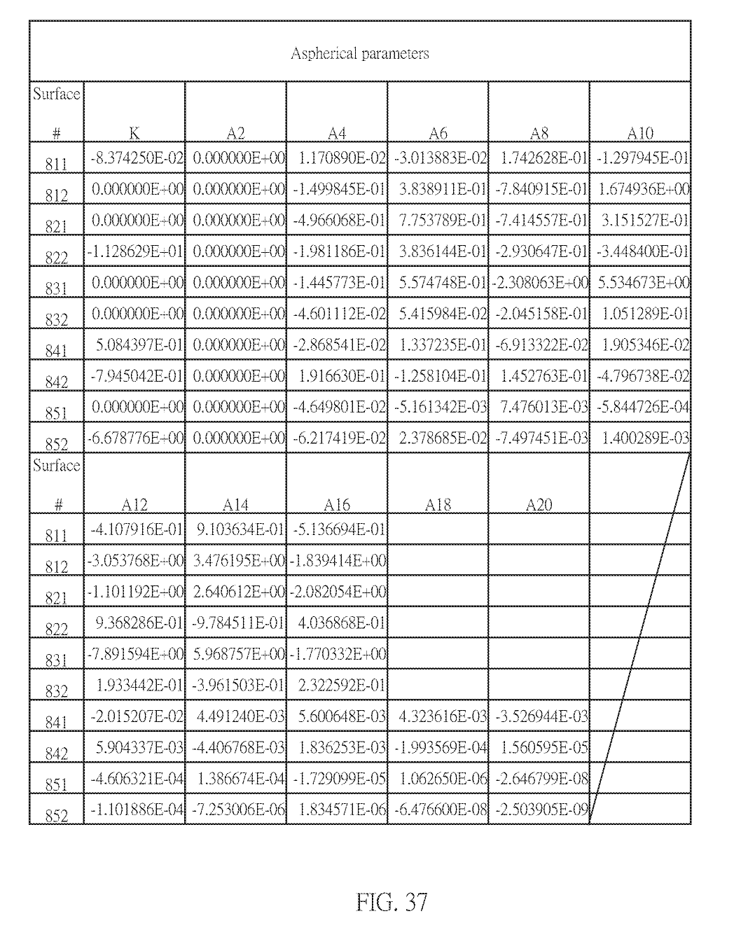

Reference is now made to FIGS. 34-37. FIG. 34 illustrates an example cross-sectional view of an optical lens assembly 8 having seven lens elements according to an eighth example embodiment. FIG. 35 shows example charts of longitudinal spherical aberration and other kinds of optical aberrations of the optical lens assembly 8 according to the eighth embodiment. FIG. 36 shows an example table of optical data of each lens element of the optical lens assembly 8 according to the eighth example embodiment. FIG. 37 shows an example table of aspherical data of the optical lens assembly 8 according to the eighth example embodiment. The reference numbers labeled in the present embodiment are similar to those in the first embodiment for the similar elements, but here the reference numbers are initialed with 8, for example, reference number 831 for labeling the object-side surface of the third lens element 830, reference number 832 for labeling the image-side surface of the third lens element 830, etc.

As shown in FIG. 34, the optical lens assembly 8 of the present embodiment, in an order from an object side A1 to an image side A2 along an optical axis, may comprise an aperture stop 800, a first lens element 810, a second lens element 820, a third lens element 830, a fourth lens element 840, and a fifth lens element 850.

The arrangement of the convex or concave surface structures, including the object-side surfaces 811, 821, 831, 841, 851, and 861 and the image-side surfaces 812, 832, 842 and 852 are generally similar to the optical lens assembly 1, but the differences between the optical lens assembly 1 and the optical lens assembly 8 may include the convex or concave surface structure of the image-side surface 822. Additional differences may include a radius of curvature, a thickness, aspherical data, and an effective focal length of each lens element. More specifically, the image-side surface 822 of the second lens element 820 may comprise a convex portion 8222 in a vicinity of a periphery of the second lens element 820.

Here, for clearly showing the drawings of the present embodiment, only the surface shapes which are different from that in the first embodiment are labeled. Please refer to FIG. 36 for the optical characteristics of each lens elements in the optical lens assembly 8 of the present embodiment.

From the vertical deviation of each curve shown in FIG. 35(a), the offset of the off-axis light relative to the image point may be within about ±0.04 mm. Referring to FIG. 35(b), the focus variation with respect to the three different wavelengths (470 nm, 555 nm, 650 nm) in the whole field may fall within about ±0.05 mm. Referring to FIG. 35(c), the focus variation with respect to the three different wavelengths (470 nm, 555 nm, 650 nm) in the whole field may fall within about ±0.06 mm. Referring to FIG. 35(d), the variation of the distortion aberration of the optical lens assembly 8 may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, the size of the aperture stop may be larger, the vertical deviation of the curve, and the astigmatism aberration may be smaller when compared with the first embodiment.

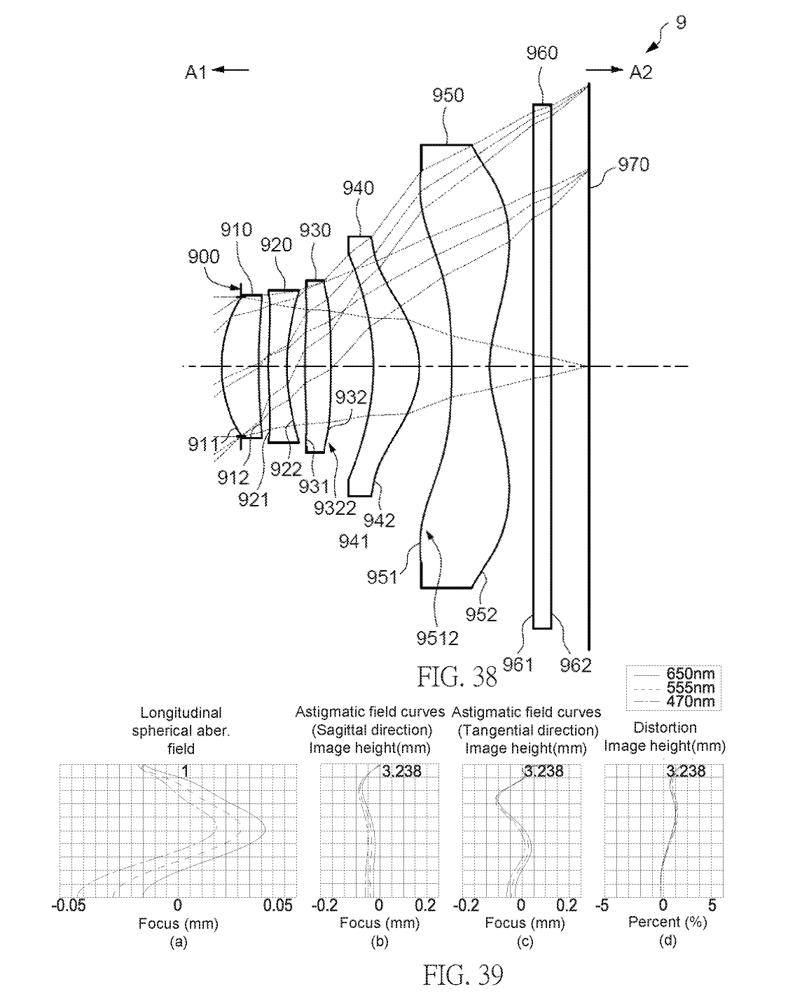

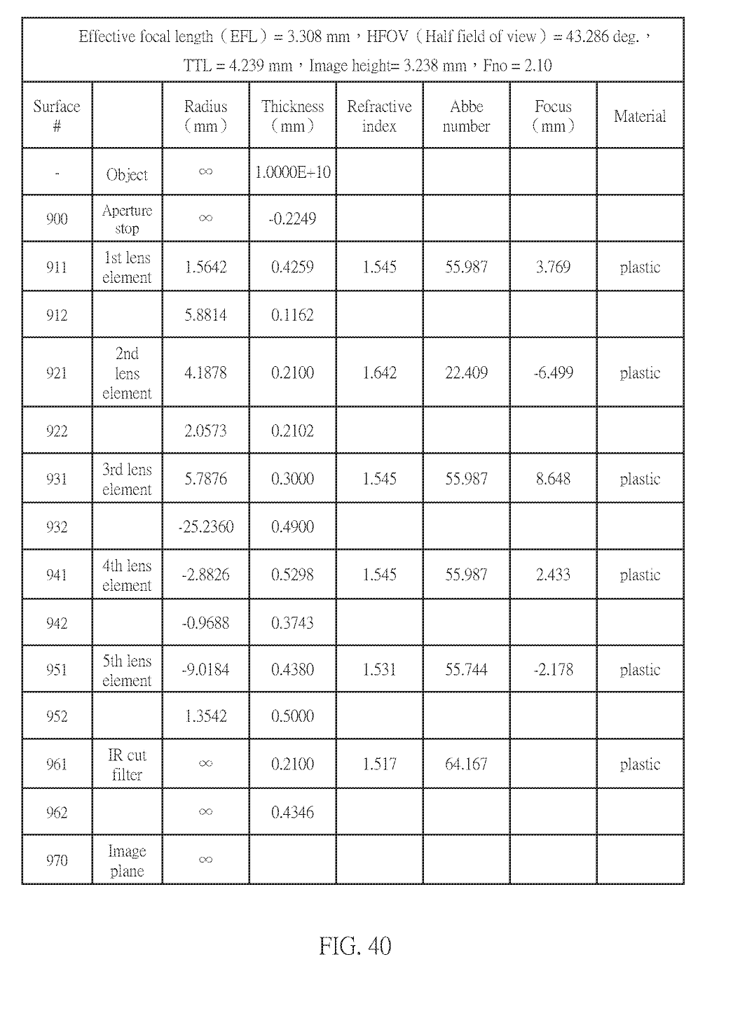

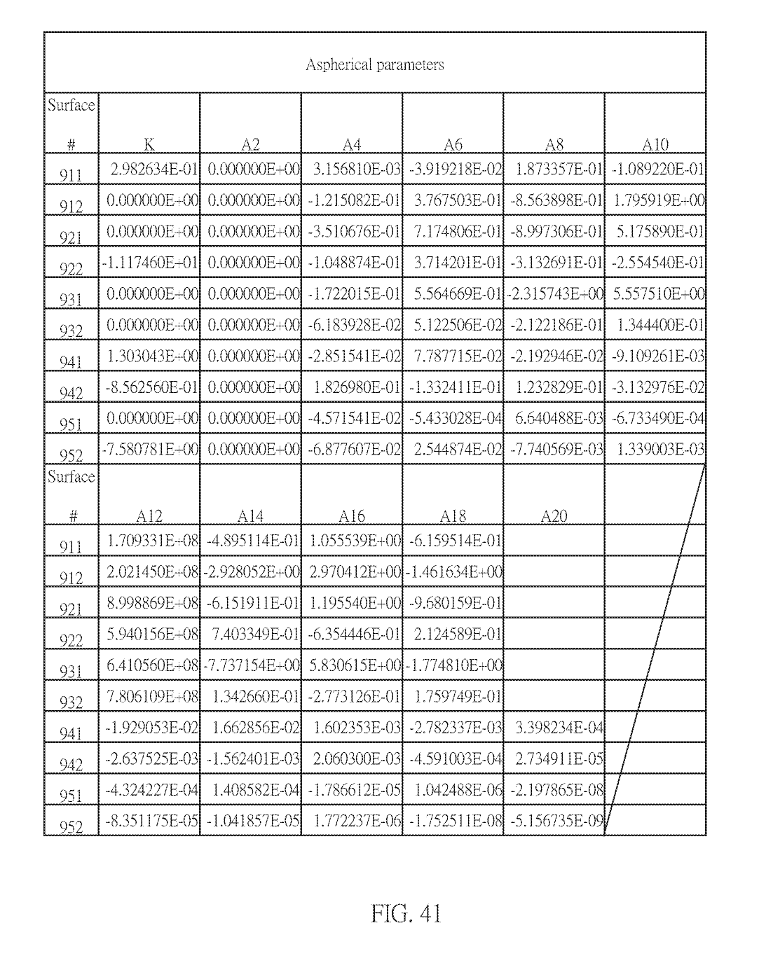

Reference is now made to FIGS. 38-41. FIG. 38 illustrates an example cross-sectional view of an optical lens assembly 9 having seven lens elements according to a ninth example embodiment. FIG. 39 shows example charts of longitudinal spherical aberration and other kinds of optical aberrations of the optical lens assembly 9 according to the ninth embodiment. FIG. 40 shows an example table of optical data of each lens element of the optical lens assembly 9 according to the ninth example embodiment. FIG. 41 shows an example table of aspherical data of the optical lens assembly 9 according to the ninth example embodiment. The reference numbers labeled in the present embodiment are similar to those in the first embodiment for the similar elements, but here the reference numbers are initialed with 9, for example, reference number 931 for labeling the object-side surface of the third lens element 930, reference number 932 for labeling the image-side surface of the third lens element 930, etc.

As shown in FIG. 38, the optical lens assembly 9 of the present embodiment, in an order from an object side A1 to an image side A2 along an optical axis, may comprise an aperture stop 900, a first lens element 910, a second lens element 920, a third lens element 930, a fourth lens element 940, and a fifth lens element 950.

The arrangement of the convex or concave surface structures, including the object-side surfaces 911, 921, 931, 941 and the image-side surfaces 912, 922, 942, 952 are generally similar to the optical lens assembly 1, but the differences between the optical lens assembly 1 and the optical lens assembly 9 may include the convex or concave surface structures of the object-side surface 951 and the image-side surface 932. Additional differences may include a radius of curvature, a thickness, aspherical data, and an effective focal length of each lens element. More specifically, the image-side surface 932 of the third lens element 930 may comprise a concave portion 9322 in a vicinity of a periphery of the third lens element 930, the object-side surface 951 of the fifth lens element 950 may comprise a convex portion 9512 in a vicinity of a periphery of the fifth lens element 950.

Here, for clearly showing the drawings of the present embodiment, only the surface shapes which are different from that in the first embodiment are labeled. Please refer to FIG. 40 for the optical characteristics of each lens elements in the optical lens assembly 9 of the present embodiment.

From the vertical deviation of each curve shown in FIG. 39(a), the offset of the off-axis light relative to the image point may be within about ±0.045 mm. Referring to FIG. 39(b), the focus variation with respect to the three different wavelengths (470 nm, 555 nm, 650 nm) in the whole field may fall within about ±0.08 mm. Referring to FIG. 39(c), the focus variation with respect to the three different wavelengths (470 nm, 555 nm, 650 nm) in the whole field may fall within about ±0.12 mm. Referring to FIG. 39(d), the variation of the distortion aberration of the optical lens assembly 9 may be within about ±2%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, the vertical deviation of the curve and the variation of the distortion aberration may be smaller when compared with the first embodiment.

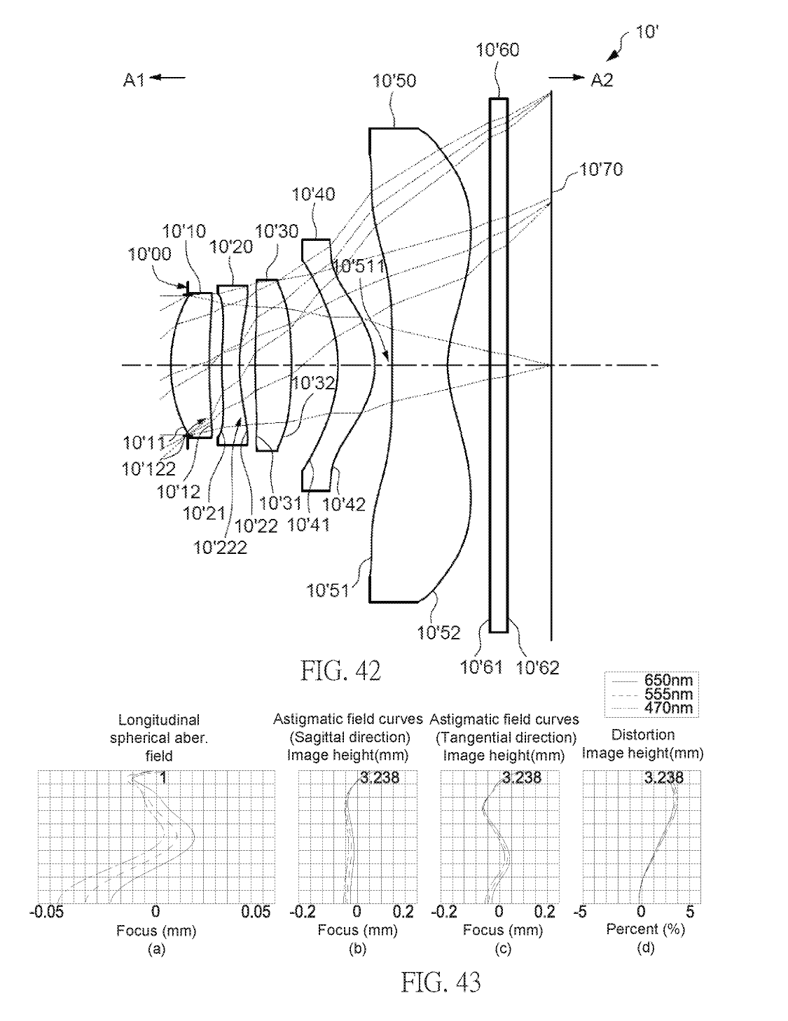

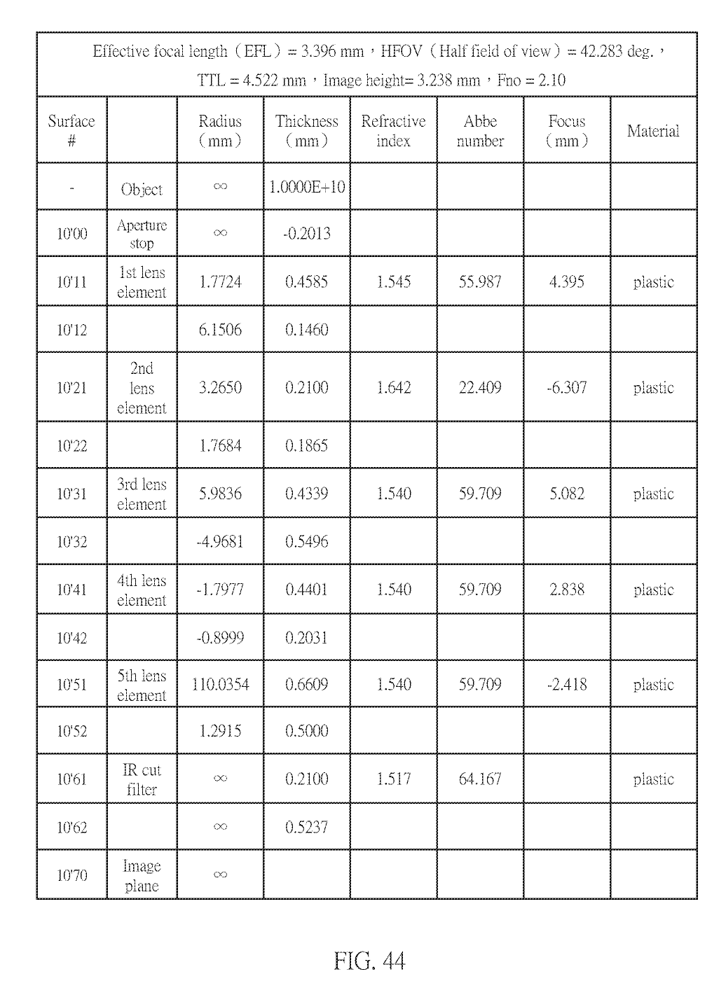

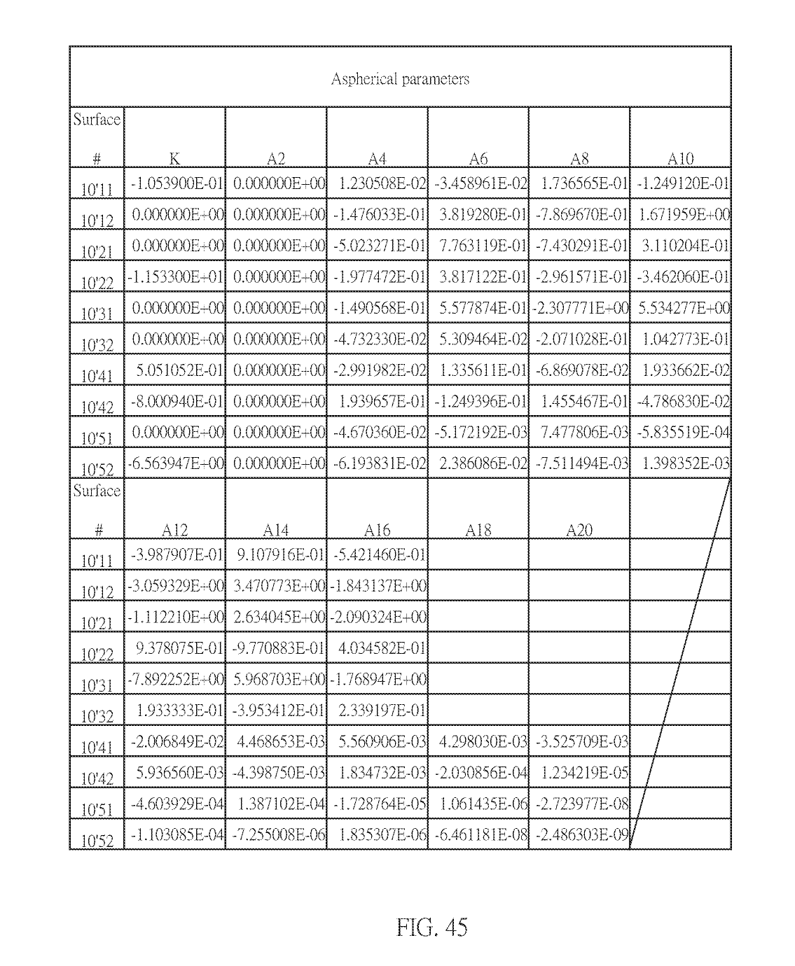

Reference is now made to FIGS. 42-45. FIG. 42 illustrates an example cross-sectional view of an optical lens assembly 10′ having seven lens elements according to a tenth example embodiment. FIG. 43 shows example charts of longitudinal spherical aberration and other kinds of optical aberrations of the optical lens assembly 10′ according to the tenth embodiment. FIG. 44 shows an example table of optical data of each lens element of the optical lens assembly 10′ according to the tenth example embodiment. FIG. 45 shows an example table of aspherical data of the optical lens assembly 10′ according to the tenth example embodiment. The reference numbers labeled in the present embodiment are similar to those in the first embodiment for the similar elements, but here the reference numbers are initialed with 10′, for example, reference number 10′31 for labeling the object-side surface of the third lens element 10′30, reference number 10′32 for labeling the image-side surface of the third lens element 10′30, etc.

As shown in FIG. 42, the optical lens assembly 10′ of the present embodiment, in an order from an object side A1 to an image side A2 along an optical axis, may comprise an aperture stop 10′00, a first lens element 10′10, a second lens element 10′20, a third lens element 10′30, a fourth lens element 10′40, and a fifth lens element 10′50.

The arrangement of the convex or concave surface structures, including the object-side surfaces 10′11, 10′21, 10′31, 10′41 and the image-side surfaces 10′32, 10′42, 10′52 are generally similar to the optical lens assembly 1, but the differences between the optical lens assembly 1 and the optical lens assembly 10′ may include the convex or concave surface structures of the object-side surface 10′51 and the image-side surfaces 10′12 and 10′22. Additional differences may include a radius of curvature, a thickness, aspherical data, and an effective focal length of each lens element. More specifically, the image-side surface 10′12 of the first lens element 10′10 may comprise a convex portion 10′122 in a vicinity of a periphery of the first lens element 10′10, the image-side surface 10′22 of the second lens element 10′20 may comprise a convex portion 10′222 in a vicinity of a periphery of the second lens element 10′20, the object-side surface 10′51 of the fifth lens element 10′50 may comprise a convex portion 10′511 in a vicinity of the optical axis.

Here, for clearly showing the drawings of the present embodiment, only the surface shapes which are different from that in the first embodiment are labeled. Please refer to FIG. 44 for the optical characteristics of each lens elements in the optical lens assembly 10′ of the present embodiment.

From the vertical deviation of each curve shown in FIG. 43(a), the offset of the off-axis light relative to the image point may be within about ±0.045 mm. Referring to FIG. 43(b), the focus variation with respect to the three different wavelengths (470 nm, 555 nm, 650 nm) in the whole field may fall within about ±0.08 mm. Referring to FIG. 43(c), the focus variation with respect to the three different wavelengths (470 nm, 555 nm, 650 nm) in the whole field may fall within about ±0.12 mm. Referring to FIG. 43(d), the variation of the distortion aberration of the optical lens assembly 10′ may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, and the vertical deviation of the curve may be smaller when compared with the first embodiment.

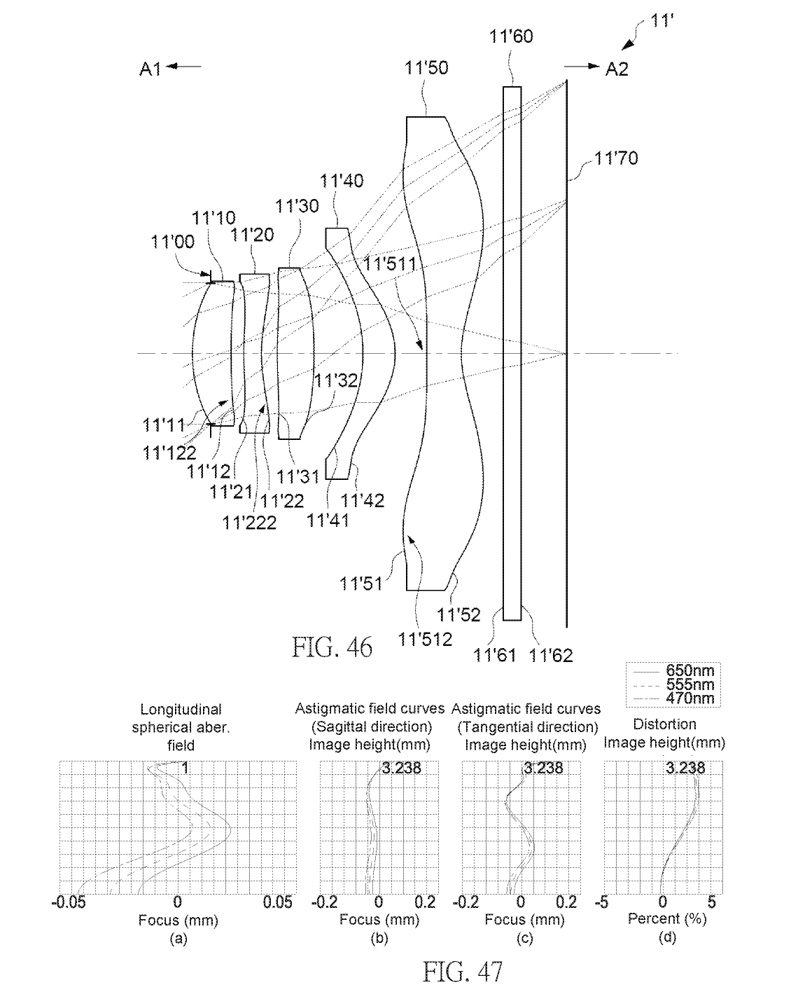

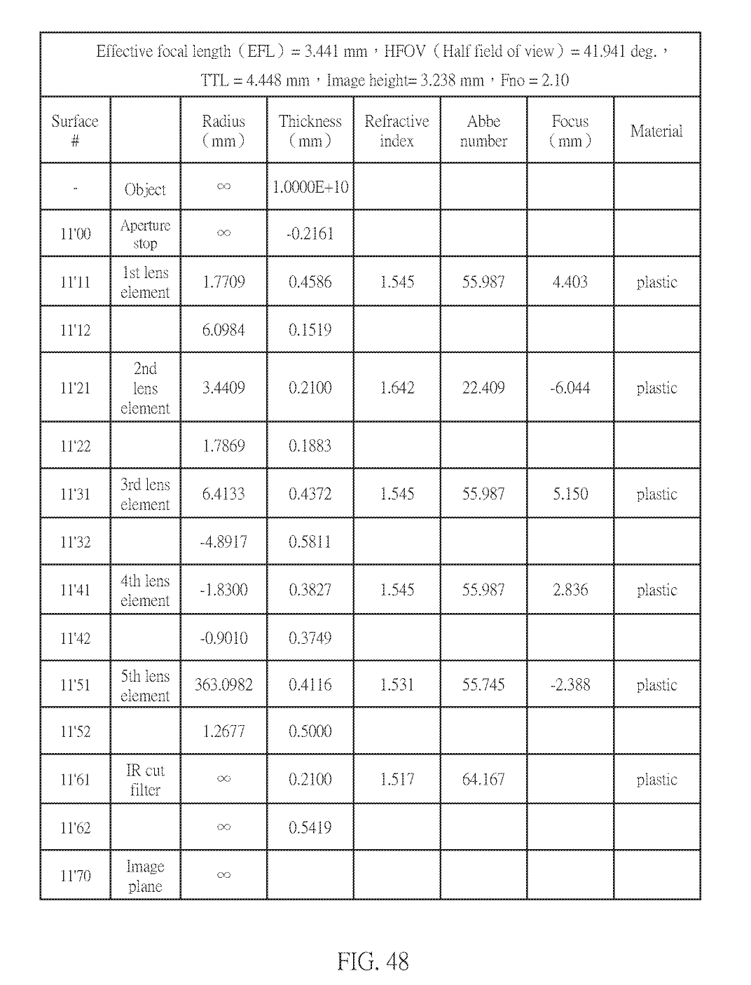

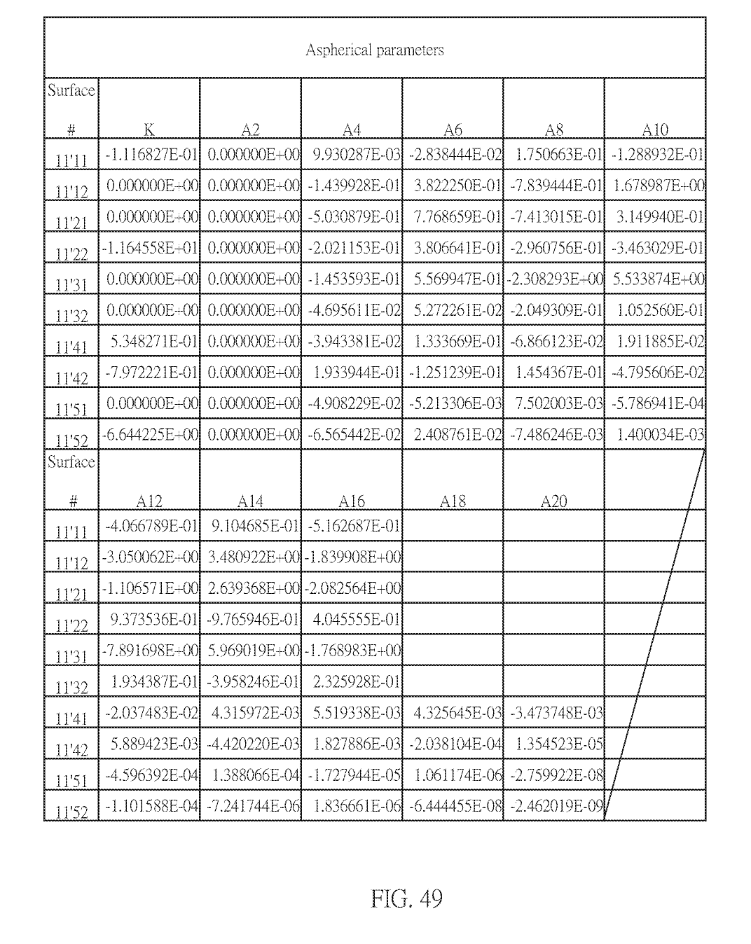

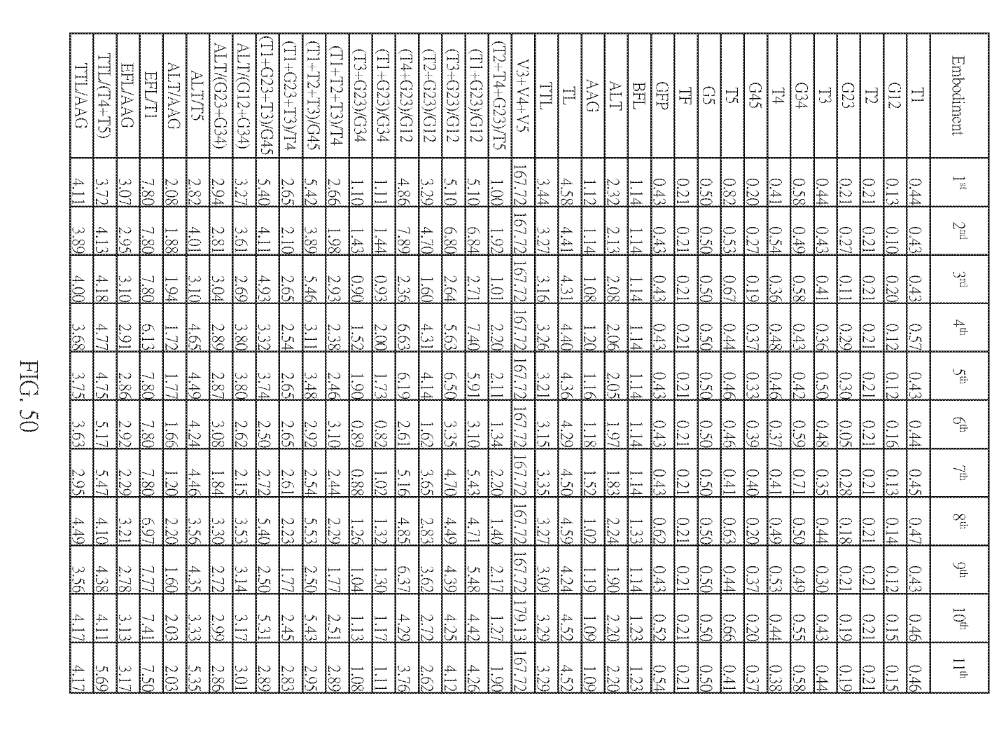

Reference is now made to FIGS. 46-49. FIG. 46 illustrates an example cross-sectional view of an optical lens assembly 11′ having seven lens elements according to a eleventh example embodiment. FIG. 47 shows example charts of longitudinal spherical aberration and other kinds of optical aberrations of the optical lens assembly 11′ according to the eleventh embodiment. FIG. 48 shows an example table of optical data of each lens element of the optical lens assembly 11′ according to the eleventh example embodiment. FIG. 49 shows an example table of aspherical data of the optical lens assembly 11′ according to the eleventh example embodiment. The reference numbers labeled in the present embodiment are similar to those in the first embodiment for the similar elements, but here the reference numbers are initialed with 11′, for example, reference number 11′31 for labeling the object-side surface of the third lens element 11′30, reference number 11′32 for labeling the image-side surface of the third lens element 11′30, etc.

As shown in FIG. 46, the optical lens assembly 11′ of the present embodiment, in an order from an object side A1 to an image side A2 along an optical axis, may comprise an aperture stop 11′00, a first lens element 11′10, a second lens element 11′20, a third lens element 11′30, a fourth lens element 11′40, and a fifth lens element 11′50.

The arrangement of the convex or concave surface structures, including the object-side surfaces 11′11, 11′21, 11′31, 11′41 and the image-side surfaces 11′32, 11′42, 11′52, are generally similar to the optical lens assembly 1, but the differences between the optical lens assembly 1 and the optical lens assembly 11′ may include the convex or concave surface structures of the object-side surface 11′51 and the image-side surface 11′12. Additional differences may include a radius of curvature, a thickness, aspherical data, and an effective focal length of each lens element. More specifically, the image-side surface 11′12 of the first lens element 11′10 may comprise a convex portion 11′122 in a vicinity of a periphery of the first lens element 11′10, the image-side surface 11′22 of the second lens element 11′20 may comprise a convex portion 11′222 in a vicinity of a periphery of the second lens element 11′20, the object-side surface 11′51 of the fifth lens element 11′50 may comprise a convex portion 11′511 in a vicinity of the optical axis and a convex portion 11′512 in a vicinity of a periphery of the fifth lens element 11′50.

Here, for clearly showing the drawings of the present embodiment, only the surface shapes which are different from that in the first embodiment are labeled. Please refer to FIG. 48 for the optical characteristics of each lens elements in the optical lens assembly 11′ of the present embodiment.

From the vertical deviation of each curve shown in FIG. 47(a), the offset of the off-axis light relative to the image point may be within about ±0.045 mm. Referring to FIG. 47(b), the focus variation with respect to the three different wavelengths (470 nm, 555 nm, 650 nm) in the whole field may fall within about ±0.08 mm. Referring to FIG. 47(c), the focus variation with respect to the three different wavelengths (470 nm, 555 nm, 650 nm) in the whole field may fall within about ±0.16 mm. Referring to FIG. 47(d), the variation of the distortion aberration of the optical lens assembly 11′ may be within about ±4%.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of this embodiment may be referred to FIG. 50.

In this embodiment, TTL may be smaller, the size of the aperture stop may be larger, the half of field of view may be bigger, and the vertical deviation of the curve may be smaller when compared with the first embodiment.

The values of T1, G12, T2, G23, T3, G34, T4, G45, T5, G5F, TF, GFP, BFL, ALT, AAG, TL, TTL, V3+V4+V5, (T2+T4+G23)/T4, (T1+G23)/G12, (T3+G23)/G12, (T2+G23)/G12, (T4+G23)/G12, (T1+G23)/G34, (T3+G23)/G34, (T1+T2+T3)/G45, (T1+G23+T3)/T4, (T1+G23+T3)/G45, ALT/(G12+G34), ALT/(G23+G34), ALT/T5, ALT/AAG, EFL/T1, EFL/AAG, TTL/(T4+T5) and TTL/AAG of all eleven embodiments may be referred to FIG. 50, and it is clear that the optical lens assemblies of the first to tenth embodiments may satisfy the Inequalities (1) to (20).

The image-side surface of the first lens element comprising a concave portion in a vicinity of the optical axis may enlarge the field of view, and the concave portion of the first lens element incorporated with the object-side surface of the second lens element comprising a convex portion in a vicinity of the optical axis may correct the aberration of the field of view. The object-side surface of the second lens element comprising a concave portion in a vicinity of a periphery region and the image-side surface of the second lens element comprising a concave portion in a vicinity of the optical axis may correct the aberration of the field of view. The object-side surface of the third lens element comprising a concave portion in a periphery region may correct the aberration of the field of view. The image-side surface of the third lens element comprising a convex portion in a vicinity of the optical axis may shorten the length of the optical lens assembly. The object-side surface of the fourth lens element comprising a concave portion in a vicinity of the optical axis may correct the aberration caused by the third lens element. The image-side surface of the fifth lens element comprising a concave portion in a vicinity of the optical axis may correct the aberrations of parallel lights.

Each of the third, fourth and fifth lens element may be made by a material whose a range of Abbe number is 45-65 for reducing aberrations caused by the third to fifth lens elements while the optical lens assembly satisfies the inequality: V3+V4+V5≥150. Moreover, a more perfect range of V3+V4+V5 may satisfy an inequality: 150≤V3+V4+V5≤195.

The length of the optical lens assembly may be shorten and a yield for manufacturing the optical lens assembly may not be lowered while the optical lens assembly satisfies the inequality: (T2+T4+G23)/T5≤2.21. Moreover, the thickness of each lens element may not be too thick while a more perfect range of (T2+T4+G23)/T5 satisfy an inequality: 1≤(T2+T4+G23)/T5≤2.21.

The length of the optical imaging or the effective focus length of the optical lens assembly may be reduced and a yield for manufacturing the optical lens assembly may not be lowered while the optical lens assembly satisfies any one of the inequalities: TTL/AAG≤4.5 or EFL/AAG≤3.4. Moreover, air gaps between adjacent lens elements may not be too big and the length of the optical lens assembly may not be increased while a more perfect range of TTL/AAG satisfy an inequality: 2.7≤TTL/AAG≤4.5 or a more perfect range of EFL/AAG satisfy an inequality: 2.1≤EFL/AAG≤3.4.

While EFL/T1 may satisfy the inequality: EFL/T1≤7.81, the values of the effective focus length and other optical parameters may be maintained in a suitable range, so that aberrations of the optical lens assembly may be corrected and difficulty of manufacturing the optical lens assembly may not be increased. Moreover, a more perfect range of EFL/T1 satisfies an inequality: 4.3≤EFL/T1≤7.81.

For shortening the length of the optical lens assembly, the thickness of each lens element and air gaps between adjacent lens elements should be decreased appropriately. However, the design of the thickness of each lens element may consider the air gaps if the optical lens assembly needs to be manufactured more easily and to provide a better imaging quality. Therefore, the arrangement of the optical lens assembly may be better while the optical lens assembly satisfies inequalities as follows:

(T1+G23)/G12≤7.4, and a more perfect range may satisfy 2.7≤(T1+G23)/G12≤7.4;

(T3+G23)/G12≤6.8, and a more perfect range may satisfy 2.6≤(T3+G23)/G12≤6.8;

(T2+G23)/G12≤4.7, and a more perfect range may satisfy 1.6≤(T2+G23)/G12≤4.7;

(T4+G23)/G12≤7.9, and a more perfect range may satisfy 2.1≤(T4+G23)/G12≤7.9;

(T1+G23)/G34≤2, and a more perfect range may satisfy 0.6≤(T1+G23)/G34≤2;

(T3+G23)/G34≤1.9, and a more perfect range may satisfy 0.6≤(T3+G23)/G34≤1.9;

(T1+T2+T3)/T4≤3.1, and a more perfect range may satisfy 0.9≤(T1+T2+T3)/T4≤3.1

(T1+T2+T3)/G45≤6.4, and a more perfect range may satisfy 2.5≤(T1+T2+T3)/G45≤6.4;

(T1+G23+T3)/T4≤2.84, and a more perfect range may satisfy 0.9≤(T1+G23+T3)/T4≤2.84;

(T1+G23+T3)/G45≤5.4, and a more perfect range may satisfy 2.5≤(T1+G23+T3)/G45≤5.4;

ALT/(G12+G34)≤3.81, and a more perfect range may satisfy 1.5≤ALT/(G12+G34)≤3.81;

ALT/(G23+G34)≤3.3, and a more perfect range may satisfy 1.3≤ALT/(G23+G34)≤3.3;

ALT/T5≤5.36, and a more perfect range may satisfy 2.3≤ALT/T5≤5.36;

ALT/AAG≤2.5, and a more perfect range may satisfy 1.19≤ALT/AAG≤2.5;

TTL/(T4+T5)≤5.7, and a more perfect range may satisfy 2.1≤TTL/(T4+T5)≤5.7.

Moreover, the optical parameters according to one embodiment could be selectively incorporated in other embodiments to limit and enhance the structure of the optical lens assembly. In consideration of the non-predictability of the optical lens assembly, while the optical lens assembly may satisfy any one of inequalities described above, the optical lens assembly herein perfectly may achieve a shorten length, provide an enlarged aperture stop, increase an imaging quality and/or assembly yield, and/or effectively improve drawbacks of a typical optical lens assembly.

Any one of the aforementioned inequalities could be selectively incorporated in other inequalities to apply to the present embodiments, but are not limited. Embodiments according to the present disclosure are not limited and could be selectively incorporated in other embodiments described herein. In some embodiments, more details about the parameters could be incorporated to enhance the control for the system performance and/or resolution. For example, the object-side surface of the first lens element may comprise a convex portion in a vicinity of the optical axis. It is noted that the details listed here could be incorporated into example embodiments if no inconsistency occurs.

While various embodiments in accordance with the disclosed principles been described above, it should be understood that they are presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical lens assembly, sequentially from an object side to an image side along an optical axis, comprising first, second, third, fourth, and fifth lens elements, each of the first, second, third, fourth, and fifth lens elements having refracting power, an object-side surface facing toward the object side, an image-side surface facing toward the image side, wherein:
the image-side surface of the first lens element comprises a concave portion in a vicinity of a periphery of the first lens element;
the object-side surface of the second lens element comprises a convex portion in a vicinity of the optical axis and a concave portion in a vicinity of a periphery of the second lens element;
the image-side surface of the second lens element comprises a concave portion in a vicinity of the optical axis;
the image-side surface of the third lens element comprises a convex portion in a vicinity of the optical axis;
the object-side surface of the fourth lens element comprises a concave portion in a vicinity of the optical axis;
the image-side surface of the fifth lens element comprises a concave portion in a vicinity of the optical axis;
an Abbe number of the third lens element is represented by V3, an Abbe number of the fourth lens element is represented by V4, an Abbe number of the fifth lens element is represented by V5, a central thickness of the second lens element along the optical axis is represented by T2, a central thickness of the fourth lens element along the optical axis is represented by T4, an air gap between the second lens element and the third lens element along the optical axis is represented by G23, a central thickness of the fifth lens element along the optical axis is represented by T5, a distance between the object-side surface of the first lens element and an image plane along the optical axis is represented by TTL, a sum of air gaps from the first to the fifth lens elements along the optical axis is represented by AAG, the optical lens assembly satisfies inequalities:
V3+V4+V5≥150;
(T2+T4+G23)/T5≤2.21; and
TTL/AAG≤4.5.

2. The optical lens assembly according to claim 1, wherein a central thickness of the first lens element along the optical axis is represented by T1, an air gap between the first lens element and the second lens element along the optical axis is represented by G12, and the optical lens assembly further satisfies an inequality: (T1+G23)/G12≤7.4.

3. The optical lens assembly according to claim 1, wherein an air gap between the first lens element and the second lens element along the optical axis is represented by G12, and the optical lens assembly further satisfies an inequality: (T2+G23)/G12≤4.7.

4. The optical lens assembly according to claim 1, wherein a central thickness of the first lens element along the optical axis is represented by T1, an air gap between the third lens element and the fourth lens element along the optical axis is represented by G34, and the optical lens assembly further satisfies an inequality: (T1+G23)/G34≤2.

5. The optical lens assembly according to claim 1, wherein a central thickness of the first lens element along the optical axis is represented by T1, a central thickness of the third lens element along the optical axis is represented by T3, and the optical lens assembly further satisfies an inequality: (T1+T2+T3)/T4≤3.1.

6. The optical lens assembly according to claim 1, wherein a central thickness of the first lens element along the optical axis is represented by T1, a central thickness of the third lens element along the optical axis is represented by T3, a central thickness of the fourth lens element along the optical axis is represented by T4, and the optical lens assembly further satisfies an inequality: (T1+G23+T3)/T4≤2.84.

7. The optical lens assembly according to claim 1, wherein a sum of central thicknesses from the first to the fifth lens elements along the optical axis is represented by ALT, an air gap between the first lens element and the second lens element along the optical axis is represented by G12, an air gap between the third lens element and the fourth lens element along the optical axis is represented by G34, and the optical lens assembly further satisfies an inequality: ALT/(G12+G34)≤3.81.

8. The optical lens assembly according to claim 1, wherein a sum of central thicknesses from the first to the fifth lens elements along the optical axis is represented by ALT, and the optical lens assembly further satisfies an inequality: ALT/T5≤5.36.

9. The optical lens assembly according to claim 1, wherein an effective focal length of the optical lens assembly is represented by EFL, a central thickness of the first lens element along the optical axis is represented by T1, and the optical lens assembly further satisfies an inequality: EFL/T1≤7.81.

10. The optical lens assembly according to claim 1, wherein a central thickness of the fourth lens element along the optical axis is represented by T4, and the optical lens assembly further satisfies an inequality: TTL/(T4+T5)≤5.7.

11. An optical lens assembly, sequentially from an object side to an image side along an optical axis, comprising first, second, third, fourth, and fifth lens elements, each of the first, second, third, fourth, and fifth lens elements having refracting power, an object-side surface facing toward the object side, an image-side surface facing toward the image side, wherein:
the image-side surface of the first lens element comprises a concave portion in a vicinity of a periphery of the first lens element;
the image-side surface of the first lens element comprises a concave portion in a vicinity of the optical axis;
the object-side surface of the second lens element comprises a convex portion in a vicinity of the optical axis and a concave portion in a vicinity of a periphery of the second lens element;
the image-side surface of the second lens element comprises a concave portion in a vicinity of the optical axis;
the image-side surface of the third lens element comprises a convex portion in a vicinity of the optical axis;
the object-side surface of the fourth lens element comprises a concave portion in a vicinity of the optical axis;
the image-side surface of the fifth lens element comprises a concave portion in a vicinity of the optical axis;
an Abbe number of the third lens element is represented by V3, an Abbe number of the fourth lens element is represented by V4, an Abbe number of the fifth lens element is represented by V5, a central thickness of the second lens element along the optical axis is represented by T2, a central thickness of the fourth lens element along the optical axis is represented by T4, an air gap between the second lens element and the third lens element along the optical axis is represented by G23, a central thickness of the fifth lens element along the optical axis is represented by T5, an effective focal length of the optical lens assembly is represented by EFL, a sum of air gaps from the first to the fifth lens elements along the optical axis is represented by AAG, the optical lens assembly satisfies inequalities:
V3+V4+V5≥150;
(T2+T4+G23)/T5≤2.21; and
EFL/AAG≤3.4.

12. The optical lens assembly according to claim 11, wherein a central thickness of the third lens element along the optical axis is represented by T3, an air gap between the first lens element and the second lens element along the optical axis is represented by G12, and the optical lens assembly further satisfies an inequality: (T3+G23)/G12≤6.8.

13. The optical lens assembly according to claim 11, wherein an air gap between the first lens element and the second lens element along the optical axis is represented by G12, and the optical lens assembly further satisfies an inequality: (T4+G23)/G12≤7.9.

14. The optical lens assembly according to claim 11, wherein a central thickness of the third lens element along the optical axis is represented by T3, an air gap between the third lens element and the fourth lens element along the optical axis is represented by G34, and the optical lens assembly further satisfies an inequality: (T3+G23)/G34≤1.9.

15. The optical lens assembly according to claim 11, wherein a central thickness of the first lens element along the optical axis is represented by T1, a central thickness of the third lens element along the optical axis is represented by T3, an air gap between the fourth lens element and the fifth lens element along the optical axis is represented by G45, and the optical lens assembly further satisfies an inequality: (T1+T2+T3)/G45≤6.4.

16. The optical lens assembly according to claim 11, wherein a central thickness of the first lens element along the optical axis is represented by T1, a central thickness of the third lens element along the optical axis is represented by T3, an air gap between the fourth lens element and the fifth lens element along the optical axis is represented by G45, and the optical lens assembly further satisfies an inequality: (T1+G23+T3)/G45≤5.41.

17. The optical lens assembly according to claim 11, wherein a sum of central thicknesses from the first to the seventh lens elements along the optical axis is represented by ALT, an air gap between the third lens element and the fourth lens element along the optical axis is represented by G34, and the optical lens assembly further satisfies an inequality: ALT/(G23+G34)≤3.31.

18. The optical lens assembly according to claim 11, wherein a sum of central thicknesses from the first to the seventh lens elements along the optical axis is represented by ALT, and the optical lens assembly further satisfies an inequality: ALT/AAG≤2.5.
